(19) United States
(12) Patent Application Publication
(10) Pub. No.: US 2025/0380312 A1
(43) Pub. Date: Dec. 11, 2025

(54) COMMUNICATION METHOD AND APPARATUS

(71) Applicant: HUAWEI TECHNOLOGIES CO., LTD., Shenzhen (CN)

(72) Inventors: Meng Shi, Shanghai (CN); Zhouqi Li, Xi'an (CN); Shuri Liao, Shanghai (CN); Shengyue Dou, Shanghai (CN)

(73) Assignee: HUAWEI TECHNOLOGIES CO., LTD., Shenzhen (CN)

(21) Appl. No.: 19/309,791

(22) Filed: Aug. 26, 2025

Related U.S. Application Data
(63) Continuation of application No. PCT/CN2024/078539, filed on Feb. 26, 2024.

(30) Foreign Application Priority Data
Feb. 28, 2023 (CN) 202310227957.9
Dec. 5, 2023 (CN) 202311665086.5

(51) Int. Cl. H04W 74/0833

(52) U.S. Cl. CPC H04W 74/0833

(57) ABSTRACT

A communication method is provided. In the method, after determining a first offset value, a terminal device decreases the first offset value, where the first offset value is used to send a random access request in advance; and the terminal device sends the random access request to a network device by using a decreased first offset value, and receives a random access response from the network device, where a timing advance adjustment value indicated by the random access response is greater than or equal to 0.

### CROSS-REFERENCE TO RELATED APPLICATIONS

This application is a continuation of International Application No. PCT/CN2024/078539, filed on Feb. 26, 2024, which claims priority to Chinese Patent Application No. 202310227957.9, filed on Feb. 28, 2023 and Chinese Patent Application No. 202311665086.5, filed on Dec. 5, 2023. All of the aforementioned patent applications are hereby incorporated by reference in their entireties.

### TECHNICAL FIELD

The embodiments relate to the field of communication technologies, and to a communication method and apparatus.

### BACKGROUND

Satellite communication is non-terrestrial network (NTN) communication. Because a satellite has advantages such as not being easily affected by natural disasters or external damage, currently, research is being conducted on using the satellite as an access network device (for example, a base station) of a mobile communication system to provide communication services for some areas such as oceans and forests. Different from a ground base station, the satellite moves at a higher speed relative to the ground and has a longer signal propagation distance. Consequently, a signal path loss of the satellite serving as the base station is larger. A communication mechanism designed for a terminal device and a ground base station in a current mobile communication system cannot be directly applied between the terminal device and a satellite base station.

In the mobile communication system, to implement slot alignment of uplink data on a base station side, when sending the uplink data, the terminal device sends the uplink data in advance based on a timing advance (TA). However, in comparison with the mobile communication system on land, NTN communication has a larger transmission delay. For example, a round-trip delay of geostationary earth orbit (GEO) satellite communication (in a regenerative mode) is 238 ms to 270 ms. A round-trip delay of low earth orbit (LEO) satellite communication (at an orbit altitude of 1200 km, in the regenerative mode) is 8 ms to 20 ms. In an initial access procedure of satellite communication, the terminal device calculates the TA based on a position of the terminal device and ephemeris information of the satellite, and sends a random access request on a physical random access channel (PRACH) based on the calculated TA. However, in satellite communication, a specific value of the timing advance is affected by factors such as a satellite coverage area, a two-way transmission delay, and high-speed satellite movement. How the terminal device calculates the timing advance to implement slot alignment and correctly receive and demodulate the uplink data of the terminal device on a network side is an urgent problem to be resolved.

### SUMMARY

The embodiments provide a communication method and apparatus to determine, in an initial access procedure, an offset value for sending a random access request in advance.

According to a first aspect, the embodiments provide a communication method. The method is performed by a terminal device or a module or a chip in the terminal device. An example in which the method is performed by the terminal device is used for description herein. The method includes: determining a first offset value, where the first offset value is used to send a random access request in advance; decreasing the first offset value, and sending the random access request to a network device by using a decreased first offset value, where a timing advance adjustment value indicated by a random access response corresponding to the random access request sent by using the decreased first offset value is greater than or equal to 0; and receiving the random access response from the network device.

According to the method provided, the terminal device determines the first offset value, and decreases the first offset value. Therefore, when the terminal device sends the random access request by using the decreased first offset value, the first offset value may be prevented from being excessively large. In this way, the timing advance adjustment value obtained by the network device based on the decreased first offset value may be large, a case in which the timing advance adjustment value obtained by the network device based on the first offset value is a negative value is avoided, and system robustness is improved.

In a possible embodiment, the decreased first offset value satisfies the following form:

$${T}_{TA 1} = ( {N}_{TA} + {N}_{TA , offset} + {N}_{TA , adj}^{common} + {N}_{TA , adj}^{UE} - {N}_{offset} ) T .$$

T_{TA1} represents the decreased first offset value, and a value of N_{TA} is determined based on an indication of the network device, or if the network device does not indicate the value of N_{TA}, the value of N_{TA} is 0; a value of N_{TA,offset} is determined based on an indication of the network device, or if the network device does not indicate the value of N_{TA,offset}, the value of N_{TA,offset} is a default value; a value of

$${N}_{TA , adj}^{common}$$

is determined based on a higher-layer parameter configured on a network side, or if the higher-layer parameter is not configured on the network side, the value of

$${N}_{TA , adj}^{common}$$

is 0; T represents a time unit; if ephemeris information of the network device is configured,

$${N}_{TA , adj}^{UE}$$

is determined based on position information of the terminal device and the ephemeris information of the network device, or if the ephemeris information of the network device is not configured, a value of

$${N}_{TA , adj}^{UE}$$

is 0; and N_{offset} is error information, and N_{offset} is greater than 0.

According to the foregoing method, factors such as the error information are considered, so that the decreased first offset value is less than the first offset value, and the decreased first offset value better meets an actual situation and is more accurate. Therefore, when the terminal device sends the random access request by using the decreased first offset value, the timing advance adjustment value obtained by the network device based on the decreased first offset value may be large (for example, may be greater than or equal to 0), and a case in which the timing advance adjustment value is a negative value is avoided.

In a possible embodiment, a value of the error information N_{offset} is indicated by the network device.

In a possible embodiment, the error information is determined based on at least one of the following:
an ephemeris calculation error, where the ephemeris calculation error is an error generated when position information of the network device is determined based on the ephemeris information; a timing error, where the timing error is an error generated when a delay between the terminal device and the network device is determined based on the position information of the terminal device and the ephemeris information of the network device; a positioning error, where the positioning error is an error generated when the position information of the terminal device is determined; and an interpolation error, where the interpolation error is an error generated when the position information of the terminal device and/or the ephemeris information of the network device are/is calculated in an interpolation manner.

In a possible embodiment, the random access response indicates the timing advance adjustment value, and the method further includes:
determining a timing advance based on the timing advance adjustment value and the decreased first offset value, where the timing advance is used to send an uplink message.

According to a second aspect, the embodiments provide a communication method. The method is performed by a network device or a module or a chip in the network device. An example in which the method is performed by the network device is used for description herein. The method includes: receiving a random access request from a terminal device, where the random access request is sent by using a decreased first offset value, and the first offset value is used to send the random access request in advance; and sending a random access response to the terminal device based on the random access request, where a timing advance adjustment value indicated by the random access response is greater than or equal to 0.

In a possible embodiment, the random access response includes the timing advance adjustment value, and the timing advance adjustment value is greater than or equal to 0.

In a possible embodiment, the decreased first offset value satisfies the following form:

$${T}_{TA 1} = ( {N}_{TA} + {N}_{TA , offset} + {N}_{TA , adj}^{common} + {N}_{TA , adj}^{UE} - {N}_{offset} ) T .$$

T_{TA1} represents the decreased first offset value, and a value of N_{TA} is determined based on an indication of the network device, or if the network device does not indicate the value of N_{TA}, the value of N_{TA} is 0; a value of N_{TA,offset} is determined based on an indication of the network device, or if the network device does not indicate the value of N_{TA,offset}, the value of N_{TA,offset} is a default value; a value of

$${N}_{TA , adj}^{common}$$

is determined based on a higher-layer parameter configured on a network side, or if the higher-layer parameter is not configured on the network side, the value of

$${N}_{TA , adj}^{common}$$

is 0; T represents a time unit; if ephemeris information of the network device is configured,

$${N}_{TA , adj}^{UE}$$

is determined based on position information of the terminal device and the ephemeris information of the network device, or if the ephemeris information of the network device is not configured, a value of

$${N}_{TA , adj}^{UE}$$

is 0; and N_{offset} is error information, and N_{offset} is greater than 0.

In a possible embodiment, a value of the error information N_{offset} is indicated by the network device.

In a possible embodiment, the error information is determined based on at least one of the following:
an ephemeris calculation error, where the ephemeris calculation error is an error generated when position information of the network device is determined based on the ephemeris information; a timing error, where the timing error is an error generated when a delay between the terminal device and the network device is determined based on the position information of the terminal device and the ephemeris information of the network device; a positioning error, where the positioning error is an error generated when the position information of the terminal device is determined; and an interpolation error, where the interpolation error is an error generated when the position information of the terminal device and/or the ephemeris information of the network device are/is calculated in an interpolation manner.

According to a third aspect, the embodiments provide a communication method. The method is performed by a terminal device or a module or a chip in the terminal device. An example in which the method is performed by the terminal device is used for description herein. The method includes: determining a second offset value based on position information of the terminal device and ephemeris information of a network device; sending a random access request to the network device by using the second offset value; and receiving a random access response from the network device, where a timing advance adjustment value indicated by the random access response is not less than 0.

In a possible embodiment, the second offset value satisfies the following form:

$${T}_{TA 2} = ( {N}_{TA} + {N}_{TA , offset} + {N}_{TA , adj}^{common} + {N}_{TA , adj 2}^{UE} ) T .$$

T represents a time unit, T_{TA2} represents the second offset value, and a value of N_{TA} is determined based on an indication of the network device, or the value is 0; a value of N_{TA,offset} is determined based on an indication of the network device, or if the network device does not indicate the value of N_{TA} offset, the value is a default value; if a higher-layer parameter is configured,

$${N}_{TA , adj}^{common}$$

is determined based on the higher-layer parameter, or if the higher-layer parameter is not configured, a value of

$${N}_{TA , adj}^{common}$$

is 0; and if the ephemeris information of the network device is configured,

$${N}_{TA , adj 2}^{UE}$$

is calculated based on the position information of the terminal device and the ephemeris information of the network device, or if the ephemeris information of the network device is not configured, a value of

$${N}_{TA , adj 2}^{UE}$$

is 0.

In a possible embodiment, in an initial access phase, the terminal device determines T_{TA2} based on

$${N}_{TA , adj 2}^{UE}$$

that is calculated based on the position information of the terminal device and the ephemeris information of the network device, and sends the random access request in advance by using T_{TA2}. The terminal device expects that after the random access request is sent by using T_{TA2}, the timing advance adjustment value received in the random access response is not less than 0.

In a possible embodiment, determining the second offset value based on the position information of the terminal device and the ephemeris information of the network device includes: determining the second offset value based on the position information of the terminal device, the ephemeris information of the network device, and error information, where the error information is determined based on at least one of an ephemeris calculation error, a synchronization signal timing error, a positioning error, and an interpolation error.

According to the method provided, factors such as the error information are considered for the second offset value determined by the terminal device, to improve accuracy of the second offset value. Further, the second offset value for which the factors such as the error information are considered is less than an existing offset value. Therefore, when the terminal device sends the random access request by using the second offset value, the timing advance adjustment value obtained by the network device based on the second offset value may be large (for example, may be greater than or equal to 0), and a case in which the timing advance adjustment value is a negative value is avoided.

In a possible embodiment, the second offset value satisfies the following form:

$${T}_{TA 2} = ( {N}_{TA} + {N}_{TA , offset} + {N}_{TA , adj}^{common} + {N}_{TA , adj}^{UE} - {N}_{offset} ) T .$$

T_{TA2} represents the second offset value, and a value of N_{TA} is determined based on an indication of the network device, or the value is 0; a value of N_{TA,offset} is determined based on an indication of the network device, or if the network device does not indicate the value of N_{TA,offset}, the value is a default value; if a higher-layer parameter is configured,

$${N}_{TA , adj}^{common}$$

is determined based on the higher-layer parameter, or if the higher-layer parameter is not configured, a value of

$${N}_{TA , adj}^{common}$$

is 0; if the ephemeris information of the network device is configured,

$${N}_{TA , adj}^{UE}$$

is calculated based on the position information of the terminal device and the ephemeris information of the network device, or if the ephemeris information of the network device is not configured, a value of

$${N}_{TA , adj}^{UE}$$

is 0; and N_{offset} is the error information, and N_{offset} is greater than 0.

In a possible embodiment,

$${N}_{TA , adj 2}^{UE}$$

satisfies either of the following forms:

$${N}_{TA , adj 2}^{UE} = {N}_{TA , adj}^{UE} - b or {N}_{TA , adj 2}^{UE} = {N}_{TA , adj}^{UE} \times δ .$$

$${N}_{TA , adj}^{UE}$$

is determined based on the position information and the ephemeris information, b and δ are determined based on the error information, b is greater than 0, and δ is greater than 0 and less than 1.

In a possible embodiment, the ephemeris calculation error is an error generated when position information of the network device is determined based on the ephemeris information; the synchronization signal timing error is an error generated when synchronization signal timing between the terminal device and the network device is determined based on the position information of the terminal device and the ephemeris information of the network device;
the positioning error is an error generated when the position information of the terminal device is determined; and
the interpolation error is an error generated when the position information of the terminal device and/or the ephemeris information of the network device are/is calculated in an interpolation manner.

According to a fourth aspect, the embodiments provide a communication method. The method is performed by a network device or a module or a chip in the network device. An example in which the method is performed by the network device is used for description herein. The method includes: receiving a random access request from a terminal device, where the random access request is sent by using a second offset value, and the second offset value is determined based on position information of the terminal device and ephemeris information of the network device; and sending a random access response to the terminal device based on the random access request, where a timing advance adjustment value indicated by the random access response is not less than 0.

In a possible embodiment, the second offset value satisfies the following form:

$${T}_{TA 2} = ( {N}_{TA} + {N}_{TA , offset} + {N}_{TA , adj}^{common} + {N}_{TA , adj}^{UE} - {N}_{offset} ) T .$$

T_{TA2} represents the second offset value, and a value of N_{TA} is determined based on an indication of the network device, or the value is 0; a value of N_{TA} offset is determined based on an indication of the network device, or if the network device does not indicate the value of N_{TA,offset}, the value is a default value; if a higher-layer parameter is configured,

$${N}_{TA , adj}^{common}$$

is determined based on the higher-layer parameter, or if the higher-layer parameter is not configured, a value of

$${N}_{TA , adj}^{common}$$

is 0; if the ephemeris information of the network device is configured,

$${N}_{TA , adj}^{UE}$$

is calculated based on the position information of the terminal device and the ephemeris information of the network device, or if the ephemeris information of the network device is not configured, a value of

$${N}_{TA , adj}^{UE}$$

is 0; and N_{offset} is error information, and N_{offset} is greater than 0.

In a possible embodiment, the second offset value satisfies the following form:

$${T}_{TA 2} = ( {N}_{TA} + {N}_{TA , offset} + {N}_{TA , adj}^{common} + {N}_{TA , adj}^{UE} ) T .$$

T represents a time unit, T_{TA2} represents the second offset value, and a value of N_{TA} is determined based on an indication of the network device, or the value is 0; a value of N_{TA,offset} is determined based on an indication of the network device, or if the network device does not indicate the value of N_{TA,offset}, the value is a default value; if a higher-layer parameter is configured,

$${N}_{TA , adj}^{common}$$

is determined based on the higher-layer parameter, or if the higher-layer parameter is not configured, a value of

$${N}_{TA , adj}^{common}$$

is 0; and if the ephemeris information of the network device is configured,

$${N}_{TA , adj 2}^{UE}$$

is calculated based on the position information of the terminal device and the ephemeris information of the network device, or if the ephemeris information of the network device is not configured, a value of

$${N}_{TA , adj 2}^{UE}$$

is 0.

In a possible embodiment,

$${N}_{TA , adj 2}^{UE}$$

satisfies either of the following forms:

$${N}_{TA , adj 2}^{UE} = {N}_{TA , adj}^{UE} - b or {N}_{TA , adj 2}^{UE} = {N}_{TA , adj}^{UE} \times δ .$$

$${N}_{TA , adj}^{UE}$$

is determined based on the position information and the ephemeris information, b and δ are determined based on the error information, b is greater than 0, and δ is greater than 0 and less than 1.

In a possible embodiment, an ephemeris calculation error is an error generated when position information of the network device is determined based on the ephemeris information; a synchronization signal timing error is an error generated when synchronization signal timing between the terminal device and the network device is determined based on the position information of the terminal device and the ephemeris information of the network device; a positioning error is an error generated when the position information of the terminal device is determined; and an interpolation error is an error generated when the position information of the terminal device and/or the ephemeris information of the network device are/is calculated in an interpolation manner.

According to a fifth aspect, the embodiments provide a communication method. The method is performed by a terminal device or a module or a chip in the terminal device. An example in which the method is performed by the terminal device is used for description herein. The method includes: receiving first information from a network device, where the first information indicates a first value; and sending a random access request to the network device, where a sending time point of the random access is request determined based on the first value, N_{TA}, N_{TA,offset},

$${N}_{TA , adj}^{comm on} , and {N}_{TA , adj}^{UE} ;$$

a value of N_{TA} is determined based on an indication of the network device, or if the network device does not indicate the value of N_{TA}, the value of N_{TA} is 0; a value of N_{TA,offset} is determined based on an indication of the network device, or if the network device does not indicate the value of N_{TA,offset}, the value of N_{TA,offset} is a default value; a value of

$${N}_{TA , adj}^{comm on}$$

is determined based on a higher-layer parameter configured on a network side, or if the higher-layer parameter is not configured on the network side, the value of

$${N}_{TA , adj}^{comm on}$$

is 0; and if ephemeris information of the network device is configured,

$${N}_{TA , adj}^{UE}$$

is determined based on position information of the terminal device and the ephemeris information of the network device, or if the ephemeris information of the network device is not configured, a value of

$${N}_{TA , adj}^{UE}$$

is 0.

Currently, because the sending time point of the random access request is estimated by the terminal device, the random access request may be sent prematurely or excessively late, and alignment cannot be implemented with the network side. As a result, data demodulation fails, and access performance is affected. However, according to the foregoing method, the network device indicates the first value to the terminal device, and when sending the random access request, the terminal device may determine the sending time point of the random access request based on the first value, so that the terminal device can accurately determine the sending time point of the random access request, and the sending time point of the random access request can be aligned with the network side, to increase a data demodulation success rate on the network side and improve access performance.

In a possible embodiment, the sending time point T_{TX1} of the random access request satisfies the following form:

$${T}_{TX 1} = {T}_{TX 2} - {T}_{TA 3} .$$

T_{TA3} is determined based on the first value N_{offset2}, N_{TA}, N_{TA,offset},

$${N}_{TA , adj}^{comm on} , and {N}_{TA , adj}^{UE} ,$$

and T_{TX2} represents a start time point of a random access channel occasion corresponding to the random access request.

In a possible embodiment, T_{TA3} satisfies the following form:

$${T}_{TA 3} = ( {N}_{TA} + {N}_{TA , offset} + {N}_{TA , adj}^{common} + {N}_{TA , adj}^{UE} - {N}_{offset 2} ) T ,$$

where the first value N_{offset2} is greater than 0; or

$${T}_{TA 3} = ( {N}_{TA} + {N}_{TA , offset} + {N}_{TA , adj}^{common} + {N}_{TA , adj}^{UE} - {N}_{offset 2} ) T ,$$

where the first value N_{offset2} is less than 0.

T represents a time unit.

In a possible embodiment, the sending time point T_{TX1} of the random access request satisfies the following form:

$${T}_{TX 1} = {T}_{TX 2} - ( {T}_{TA} - {N}_{offset 2} ) or {T}_{TX 1} = {T}_{TX 2} - ( {T}_{TA} - {N}_{offset 2} \times T ) .$$

N_{offset2} represents the first value, the first value is greater than 0, T_{TA} represents a first offset value, T_{TA} is determined based on N_{TA}, N_{TA,offset},

$${N}_{TA , adj}^{c o m m o n} , and {N}_{TA , adj}^{UE} ,$$

T_{TX2} represents a start time point of a random access channel occasion corresponding to the random access request, and T represents a time unit.

In a possible embodiment, the sending time point T_{TX1} of the random access request satisfies the following form:

$${T}_{T X 1} = {T}_{T X 2} - ( {T}_{T A} + {N}_{offset 2} ) or {T}_{T X 1} = {T}_{T X 2} - ( {T}_{T A} + {N}_{offset 2} \times T ) .$$

N_{offset2} represents the first value, the first value is less than 0, T_{TA} represents a first offset value, T_{TA} is determined based on N_{TA}, N_{TA,offset},

$${N}_{TA , adj}^{c o m m o n} , and {N}_{TA , adj}^{UE} ,$$

T_{TX2} represents a start time point of a random access channel occasion corresponding to the random access request, and T represents a time unit.

In a possible embodiment, the first value is determined based on at least one of the following:
an ephemeris calculation error, where the ephemeris calculation error is an error generated when position information of the network device is determined based on the ephemeris information;
a timing error, where the timing error is an error generated when a delay between the terminal device and the network device is determined based on the position information of the terminal device and the ephemeris information of the network device;
a positioning error, where the positioning error is an error generated when the position information of the terminal device is determined; and
an interpolation error, where the interpolation error is an error generated when the position information of the terminal device and/or the ephemeris information of the network device are/is calculated in an interpolation manner.

In a possible embodiment, the method further includes: receiving a random access response from the network device, where the random access response indicates a timing advance adjustment value.

In a possible embodiment, the timing advance adjustment value is greater than or equal to 0.

In a possible embodiment, the method further includes: determining a timing advance based on the timing advance adjustment value and the first value, where the timing advance is used to send an uplink message.

According to a sixth aspect, the embodiments provide a communication method. The method is performed by a network device or a module or a chip in the network device. An example in which the method is performed by the network device is used for description herein. The method includes: sending first information, where the first information indicates a first value; the first value, N_{TA}, N_{TA,offset},

$${N}_{TA , adj}^{c o m m o n} , and {N}_{TA , adj}^{UE} ,$$

are used to determine a sending time point of a random access request; a value of N_{TA} is determined based on an indication of the network device, or if the network device does not indicate the value of N_{TA}, the value of N_{TA} is 0; a value of N_{TA,offset} is determined based on an indication of the network device, or if the network device does not indicate the value of N_{TA,offset}, the value of N_{TA,offset} is a default value; a value of

$${N}_{TA , adj}^{c o m m o n}$$

is determined based on a higher-layer parameter configured on a network side, or if the higher-layer parameter is not configured on the network side, the value of

$${N}_{TA , adj}^{c o m m o n}$$

is 0; and if ephemeris information of the network device is configured,

$${N}_{T A , a d j}^{U B}$$

is determined based on a position information of a terminal device and the ephemeris information of the network device, or if the ephemeris information of the network device is not configured, a value of

$${N}_{TA , adj}^{UE}$$

is 0; and receiving the random access request from the terminal device.

In a possible embodiment, the sending time point T_{TX1} of the random access request satisfies the following form:

$${T}_{T X 1} = {T}_{T X 2} - {T}_{T A 3} .$$

T_{TA3} is determined based on the first value N_{offset2}, N_{TA}, N_{TA,offset},

$${N}_{TA , adj}^{c o m m o n} , and {N}_{TA , adj}^{UE} ,$$

T_{TX2} represents a start time point of a random access channel occasion corresponding to the random access request.

In a possible embodiment, T_{TA3} satisfies the following form:

$${T}_{T A 3} = ( {N}_{T A} + {N}_{TA , offset} + {N}_{T A , a d j}^{c o m m o n} + {N}_{TA , adj}^{UE} - {N}_{offset 2} ) T ,$$

where the first value N_{offset2} is greater than 0; or

$${T}_{T A 3} = ( {N}_{T A} + {N}_{TA , offset} + {N}_{T A , a d j}^{c o m m o n} + {N}_{TA , adj}^{UE} + {N}_{offset 2} ) T ,$$

where the first value N_{offset2} is less than 0.

T represents a time unit.

In a possible embodiment, the sending time point T_{TX1} of the random access request satisfies the following form:

$${T}_{T X 1} = {T}_{T X 2} - ( {T}_{T A} - {N}_{offset 2} ) or {T}_{T X 1} = {T}_{T X 2} - ( {T}_{T A} - {N}_{offset 2} \times T ) .$$

N_{offset2} represents the first value, the first value is greater than 0, T_{TA} represents a first offset value, T_{TA} is determined based on N_{TA}, N_{TA,offset},

$${N}_{TA , adj}^{c o m m o n} , and {N}_{TA , adj}^{UE} ,$$

T_{TX2} represents a start time point of a random access channel occasion corresponding to the random access request, and T represents a time unit.

In a possible embodiment, the sending time point T_{TX1} of the random access request satisfies the following form:

$${T}_{T X 1} = {T}_{T X 2} - ( {T}_{T A} + {N}_{offset 2} ) or {T}_{T X 1} = {T}_{T X 2} - ( {T}_{T A} + {N}_{offset 2} \times T ) .$$

N_{offset2} represents the first value, the first value is less than 0, T_{TA} represents a first offset value, T_{TA} is determined based on N_{TA}, N_{TA,offset},

$${N}_{TA , adj}^{common} , and {N}_{TA , adj}^{UE} ,$$

T_{TX2} represents a start time point of a random access channel occasion corresponding to the random access request, and T represents a time unit.

In a possible embodiment, the first value is determined based on at least one of the following:
an ephemeris calculation error, where the ephemeris calculation error is an error generated when position information of the network device is determined based on the ephemeris information;
a timing error, where the timing error is an error generated when a delay between the terminal device and the network device is determined based on the position information of the terminal device and the ephemeris information of the network device;
a positioning error, where the positioning error is an error generated when the position information of the terminal device is determined; and
an interpolation error, where the interpolation error is an error generated when the position information of the terminal device and/or the ephemeris information of the network device are/is calculated in an interpolation manner.

In a possible embodiment, the method further includes: receiving a random access response from the network device, where the random access response indicates a timing advance adjustment value.

In a possible embodiment, the timing advance adjustment value is greater than or equal to 0.

According to a seventh aspect, an embodiment provides a communication apparatus. The apparatus may be used in a terminal device, and has a function of implementing the method performed by the terminal device in the first aspect, the third aspect, or the fifth aspect. The function may be implemented by hardware, or may be implemented by hardware executing corresponding software. The hardware or the software includes one or more units corresponding to the function. For example, a communication unit and a processing unit are included. The communication unit may also be referred to as a transceiver unit or a transceiver module. The communication unit may include a receiving unit and a sending unit. The processing unit may also be referred to as a processing module.

In an embodiment, the communication apparatus is a communication chip, and the communication unit may be an input/output circuit or a port, a communication interface, an output circuit, an input circuit, a pin, a related circuit, or the like of the communication chip. The processing unit may be a processing circuit or a logic circuit of the communication chip.

Optionally, the communication apparatus may further include one or more memories. The memory is configured to be coupled to a processor, and stores necessary program instructions and/or data. The one or more memories may be integrated with the processor, or may be disposed independent of the processor. This is not limited.

In another implementation, the communication apparatus includes a communication interface, a processor, and a memory. The processor is configured to control the communication interface to receive and send a signal. The memory is configured to store a computer program. The processor is configured to run the computer program in the memory, to enable the communication apparatus to perform the method in any one of the first aspect or the possible embodiments of the first aspect, enable the communication apparatus to perform the method in any one of the third aspect or the possible embodiments of the third aspect, or enable the communication apparatus to perform the method in any one of the fifth aspect or the possible embodiments of the fifth aspect.

According to an eighth aspect, an embodiment provides a communication apparatus. The apparatus may be used in a network device, and has a function of implementing the method performed by the network device in the second aspect, the fourth aspect, or the sixth aspect. The function may be implemented by hardware, or may be implemented by hardware executing corresponding software. The hardware or the software includes one or more units corresponding to the function. For example, a communication unit and a processing unit are included. The communication unit may also be referred to as a transceiver unit or a transceiver module. The communication unit may include a receiving unit and a sending unit. The processing unit may also be referred to as a processing module.

In an embodiment, the communication apparatus is a communication chip, and the communication unit may be an input/output circuit or a port, a communication interface, an output circuit, an input circuit, a pin, a related circuit, or the like of the communication chip. The processing unit may be a processing circuit or a logic circuit of the communication chip.

Optionally, the communication apparatus may further include one or more memories. The memory is configured to be coupled to a processor, and stores necessary program instructions and/or data. The one or more memories may be integrated with the processor, or may be disposed independent of the processor. This is not limited.

In another embodiment, the communication apparatus includes a communication interface, a processor, and a memory. The processor is configured to control the communication interface to receive and send a signal. The memory is configured to store a computer program. The processor is configured to run the computer program in the memory, to enable the communication apparatus to perform the method in any one of the second aspect or the possible embodiments of the second aspect, enable the communication apparatus to perform the method in any one of the fourth aspect or the possible embodiments of the fourth aspect, or enable the communication apparatus to perform the method in any one of the sixth aspect or the possible embodiments of the sixth aspect.

According to a ninth aspect, a non-transitory computer-readable storage medium is provided, and is used to store a computer program. The computer program includes instructions used to perform the method in any one of the first aspect or the possible embodiments of the first aspect, the computer program includes instructions used to perform the method in any one of the third aspect or the possible embodiments of the third aspect, or the computer program includes instructions used to perform the method in any one of the fifth aspect or the possible embodiments of the fifth aspect.

According to a tenth aspect, a non-transitory computer-readable storage medium is provided, and is used to store a computer program. The computer program includes instructions used to perform the method in any one of the second aspect or the possible embodiments of the second aspect, the computer program includes instructions used to perform the method in any one of the fourth aspect or the possible embodiments of the fourth aspect, or the computer program includes instructions used to perform the method in any one of the sixth aspect or the possible embodiments of the sixth aspect.

According to an eleventh aspect, a computer program product is provided. The computer program product includes computer program code. When the computer program code is run on a computer or a communication apparatus, the computer or the communication apparatus is enabled to perform the method in any one of the first aspect or the possible embodiments of the first aspect, the computer or the communication apparatus is enabled to execute instructions of the method in any one of the third aspect or the possible embodiments of the third aspect, or the computer or the communication apparatus is enabled to execute instructions of the method in any one of the fifth aspect or the possible embodiments of the fifth aspect.

According to a twelfth aspect, a computer program product is provided. The computer program product includes computer program code. When the computer program code is run on a computer or a communication apparatus, the computer or the communication apparatus is enabled to perform the method in any one of the second aspect or the possible embodiments of the second aspect, the computer or the communication apparatus is enabled to execute instructions of the method in any one of the fourth aspect or the possible embodiments of the fourth aspect, or the computer or the communication apparatus is enabled to execute instructions of the method in any one of the sixth aspect or the possible embodiments of the sixth aspect.

According to a thirteenth aspect, an embodiment further provides a chip, including a processor. The processor is configured to invoke a computer program or computer instructions in a memory, to enable the processor to perform any one of the possible embodiments of the first aspect, enable the processor to execute instructions of the method in any one of the possible embodiments of the third aspect, or enable the processor to execute instructions of the method in any one of the fifth aspect or the possible embodiments of the fifth aspect.

In an embodiment, the processor is coupled to the memory through an interface.

According to a fourteenth aspect, an embodiment further provides a chip, including a processor. The processor is configured to invoke a computer program or computer instructions in a memory, to enable the processor to perform any one of the possible embodiments of the second aspect, enable the processor to execute instructions of the method in any one of the possible embodiments of the fourth aspect, or enable the processor to execute instructions of the method in any one of the sixth aspect or the possible embodiments of the sixth aspect.

In an embodiment, the processor is coupled to the memory through an interface.

According to a fifteenth aspect, an embodiment provides a communication system. The communication system includes the communication apparatus (for example, the terminal device) in the fifth aspect and the communication apparatus (for example, the network device) in the sixth aspect. Alternatively, the communication system includes a terminal device configured to implement any one of the first aspect or the possible embodiments of the first aspect, and a network device configured to implement any one of the second aspect or the possible embodiments of the second aspect. Alternatively, the communication system includes a terminal device configured to implement any one of the fifth aspect or the possible embodiments of the fifth aspect, and a network device configured to implement any one of the sixth aspect or the possible embodiments of the sixth aspect.

These aspects or another aspect of the re are clearer and more comprehensible in descriptions of the following embodiments.

### BRIEF DESCRIPTION OF DRAWINGS

FIG. 1 is a diagram of an architecture of a non-terrestrial network communication system to which an embodiment is applicable;

FIG. 2 is a diagram of an architecture of a non-terrestrial network communication system to which an embodiment is applicable;

FIG. 3 is a diagram of an architecture of a non-terrestrial network communication system to which an embodiment is applicable;

FIG. 4 is a diagram of a timing advance according to an embodiment;

FIG. 5 is a schematic flowchart of a communication method according to an embodiment;

FIG. 6 is a diagram of message transmission according to an embodiment;

FIG. 7 is a schematic flowchart of a communication method according to an embodiment;

FIG. 8 is a schematic flowchart of a communication method according to an embodiment;

FIG. 9 is a schematic flowchart of a communication method according to an embodiment;

FIG. 10 is a diagram of a structure of a communication apparatus according to an embodiment;

FIG. 11 is a diagram of a structure of a communication apparatus according to an embodiment; and

FIG. 12 is a diagram of a structure of a communication apparatus according to an embodiment.

### DETAILED DESCRIPTION OF EMBODIMENTS

The following clearly describes the solutions in embodiments with reference to the accompanying drawings. It is clear that the described embodiments are merely some, but not all, of the embodiments. The terms “first”, “second”, corresponding term numbers, and the like in the embodiments and the accompanying drawings are used to distinguish between similar objects, and are not necessarily used to describe a specific sequence or order. It should be understood that the terms used in such a way are interchangeable in appropriate circumstances, and this is merely a distinguishing manner used when objects having a same attribute are described in embodiments. In addition, the terms “include”, “have”, and any variations thereof mean to cover a non-exclusive inclusion, so that a process, method, system, product, or device that includes a series of units is not limited to those units, but may include other units not expressly listed or inherent to such a process, method, product, or device.

A communication method provided in embodiments may be applied to various mobile communication systems. For example, the mobile communication system may be a long term evolution (LTE) system formulated by the 3rd generation partnership project (3GPP), may be a 5th generation (5G) communication system (for example, 5G new radio (NR)), may be a non-terrestrial network (NTN), or may be a new communication system that emerges in 6G or future communication development. Alternatively, the communication system may be a machine to machine (M2M) network, a machine type communication (MTC) network, or another network.

The method and an apparatus provided in embodiments are based on a same concept or similar concepts. Because problem-resolving principles of the method and the apparatus are similar, mutual reference may be made to embodiments of the apparatus and implementation of the method. Repeated parts are not described in detail.

A communication apparatus in the embodiments may be an apparatus, a device, a chip, or a module that can communicate with another device in a wireless and/or wired manner, and includes, but is not limited to, an apparatus or a device such as a network device or a terminal device.

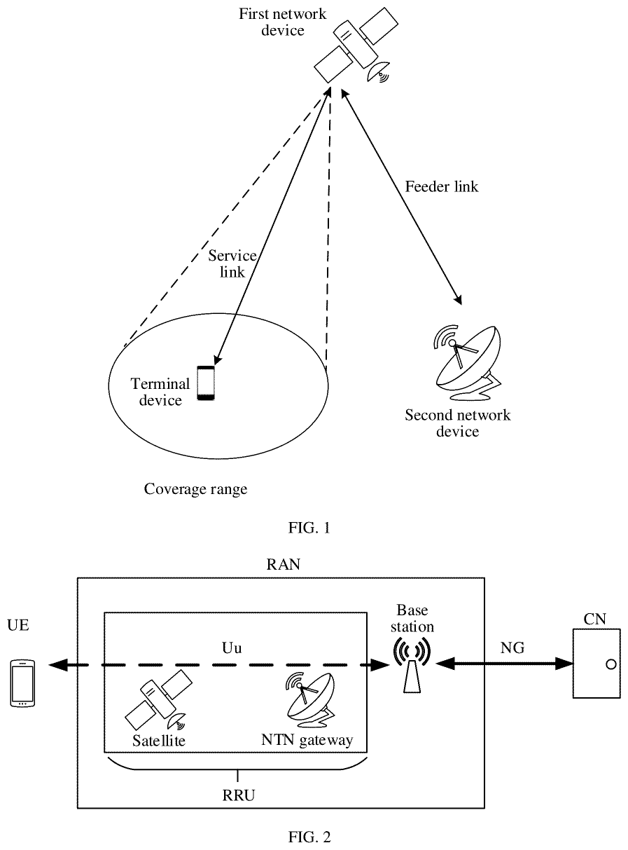

The method provided in embodiments may be applied to a non-terrestrial network communication system. FIG. 1 is a diagram of an architecture of a non-terrestrial network communication system to which an embodiment is applicable. The communication system may include a terminal device, a first network device, and a second network device. A communication link between the first network device and the second network device is a feedback link (also referred to as a feeder link); and a communication link between the first network device and the terminal device is a service link.

The first network device may be a satellite (also referred to as a satellite base station), including, but not limited to, a geostationary earth orbit (GEO) satellite, a medium earth orbit (MEO) satellite and a low earth orbit (LEO) satellite in a non-geostationary earth orbit (NGEO), a high altitude communication platform (HAPS), or the like. This is not limited herein.

In this embodiment, communication modes of the first network device may include a regenerative mode and a transparent mode.

When the communication mode of the first network device is the regenerative mode, the first network device may serve as a base station for wireless communication. For example, the first network device may be an artificial earth satellite or a high-altitude aircraft that serves as a base station for wireless communication, for example, an evolved NodeB (eNB) or a 5G base station (gNB). The first network device may perform transparent transmission on signaling between the first network device and a core network.

When the communication mode of the first network device is the transparent mode, the first network device serves as a base station for wireless communication, and the first network device may serve as a relay of the base stations and may perform transparent transmission on a signal between the first network device and the terminal device.

The first network device may communicate with the terminal device by using a beam. The first network device adjusts a weight of an antenna, so that a beam of the satellite may point to different directions and have different coverage ranges.

The second network device may be a gateway (also referred to as a terrestrial station, an earth station, or a gateway station), and may be configured to connect the first network device to the core network.

In the embodiments, after the satellite transmits a radio signal through the antenna by using a spatial parameter, a specific coverage range is formed in a specified spatial direction, and a terminal device in the coverage range may communicate with the satellite. The coverage range may also be referred to as a beam or a cell. The spatial parameter may also be understood as a beam, and the beam is a main lobe of a directional array pattern of a signal sent by the satellite. The satellite may adjust the weight of the antenna, so that the beam may point to different directions and have different coverage ranges.

In the embodiments, the spatial parameter may be referred to as another name, for example, may be referred to as any one of the following names: a beam, a spatial domain filter, a spatial filter, a spatial domain parameter, a spatial domain setting, a spatial setting, quasi-colocation (QCL) information, a QCL assumption, or a QCL indication. In the embodiments, the spatial parameter may be replaced with terms such as the beam, the spatial domain filter, the spatial filter, the spatial domain parameter, a space parameter, the spatial domain setting, the spatial setting, the QCL information, the QCL assumption, the QCL indication, or a spatial relationship. This is not limited herein.

In the embodiments, the terminal device may also be referred to as a terminal, user equipment (UE), a mobile station, a mobile terminal, or the like. The terminal device may be a mobile phone, a tablet computer, a computer having a wireless transceiver function, a virtual reality terminal device, an augmented reality terminal device, a wireless terminal in industrial control, a wireless terminal in self-driving, a wireless terminal in remote surgery, a wireless terminal in a smart grid, a wireless terminal in transportation safety, a wireless terminal in a smart city, a wireless terminal in a smart home, or the like. A specific technology and a specific device form that are used by the terminal device are not limited.

In the embodiments, the network device may also be referred to as an access network device, and includes, but is not limited to, a satellite, an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (BBU), an access point (AP) in a wireless fidelity (Wi-Fi) system, a wireless relay node, a wireless backhaul node, a transmission point (TP), a transmission reception point (TRP), or the like; or may be a network device in a 5G mobile communication system, for example, a next generation NodeB (gNB), a transmission reception point (TRP), or a TP in an NR system; or one antenna panel or one group of antenna panels (including a plurality of antenna panels) of a base station in the 5G mobile communication system. Alternatively, the network device may be a network node that forms a gNB or a transmission point, for example, a BBU or a distributed unit (DU).

In some deployments or embodiments, the gNB may include a central unit (CU) and a DU. The gNB may further include an active antenna unit (AAU). The CU implements some functions of the gNB, and the DU implements some functions of the gNB. For example, the CU is responsible for processing a non-real-time protocol and service, and implements functions of a radio resource control (RRC) layer and a packet data convergence protocol (PDCP) layer. The DU is responsible for processing a physical layer protocol and a real-time service, and implements functions of a radio link control (RLC) layer, a medium access control (MAC) layer, and a physical (PHY) layer. The AAU implements some physical layer processing functions, radio frequency processing, and a function related to an active antenna. Information at the RRC layer is then changed to information at the PHY layer, or is changed from the information at the PHY layer. Therefore, in this architecture, higher layer signaling (for example, RRC layer signaling) may also be considered to be sent by the DU, or sent by the DU and the AAU. It may be understood that the network device may be a device including one or more of a CU node, a DU node, and an AAU node. In addition, the CU may be classified as a network device in a RAN, or the CU may be classified as a network device in the core network (CN). This is not limited.

It may be understood that, in different systems, the CU (including a CU-CP or a CU-UP) or the DU may alternatively have different names, but a person skilled in the art can understand meanings of the names. For example, in an open radio access network (O-RAN) system, the CU may also be referred to as an O-CU (open CU), the DU may also be referred to as an O-DU, the CU-CP may also be referred to as an O-CU-CP, and the CU-UP may also be referred to as an O-CU-UP. For ease of description, the CU, the CU-CP, the CU-UP, and the DU are used as examples for description in the embodiments. The network device may further include an active antenna unit (AAU). The CU implements some functions of the gNB, and the DU implements some functions of the gNB. For example, the CU is responsible for processing the non-real-time protocol and service, and implements the function of the RRC layer. The DU is responsible for processing the physical layer protocol and the real-time service, and implements the functions of the radio link control (RLC) layer, the medium access control (MAC) layer, and the physical (PHY) layer. In some deployments, the CU may be further divided into a central unit control plane (CU-CP) node and a central unit user plane (CU-UP) node. The CU-CP is responsible for a control plane function, and the CU-UP is responsible for a user plane function.

FIG. 2 is a diagram of another network architecture to which the embodiments are applicable. As shown in FIG. 2, a terminal device communicates with a ground base station through a Uu interface. A satellite may implement transparent payload transmission between the terminal device and the ground base station. The satellite and an NTN gateway may be considered as remote radio units (RRUs) of the ground base station, and implement transparent forwarding of a signal. In other words, the satellite supports functions such as radio frequency filtering, frequency conversion, and amplification, and a signal waveform remains unchanged. Forwarding of the satellite is transparent to the terminal device. The ground base station and a core network (CN) may communicate with each other through a next generation (NG) network interface, and exchange non-access stratum (NAS) signaling of the core network and service data of the terminal device through the NG interface.

FIG. 3 is a diagram of another network architecture to which the embodiments are applicable. A satellite has some or all functions of a network device, and may be referred to as a satellite base station. The satellite may provide a radio access service, and schedule a radio resource for a terminal device that accesses a network through the satellite. The satellite communicates with the terminal device through a Uu interface. The satellite and a CN may communicate with each other through an NG interface, and the satellite and the core network may exchange NAS signaling and service data of the terminal device through the NG interface. A satellite radio interface (SRI) is a feeder link between an NTN gateway and the satellite. In FIG. 3, the SRI interface may be used as a part of the NG interface to implement communication and interaction between the satellite and the core network.

In a communication system, a signal delay causes a signal sent by a transmit end to be not aligned with a signal received by a receive end in terms of a frequency and time, severely affecting communication performance. For example, in a scenario in which the communication system modulates a signal by using an orthogonal frequency division multiplexing (OFDM) technology, the signal delay damages orthogonality between signal subcarriers, and causes interference between the subcarriers and/or between time symbols (for example, OFDM symbols). Consequently, signal demodulation performance of the receive end is greatly reduced. Therefore, the communication system needs to estimate and compensate for the signal delay, to minimize a time difference between signals whose transmission is performed between the transmit end and the receive end, so as to ensure communication performance of the system.

To ensure orthogonality of uplink transmission and avoid intra-cell interference, the network device requires that time points at which uplink frames that are of different terminal devices and that are from a same subframe but different frequency domain resources (different resource blocks) arrive at the network device are basically aligned. The network device can correctly decode the uplink frame sent by the terminal device, provided that the network device receives the uplink frame within a cyclic prefix (CP) range. Therefore, uplink synchronization requires that time points at which uplink frames that are of different terminal devices and that are from a same subframe arrive at the network device fall within the CP range. To ensure that the uplink frame of the terminal device arrives at the network device at a time point expected by the network device, an uplink timing advance mechanism may be used. In the uplink timing advance mechanism, the terminal device may send the uplink frame in advance by specified time, and the specified time is time corresponding to a timing advance.

From a perspective of a network device side, the uplink timing advance mechanism may be used to align a start time point of a downlink subframe sent by the network device with a start time point of an uplink subframe received by the network device. From a perspective of a terminal device side, a start time point of an uplink subframe sent by the terminal device has an advance relative to a start time point of a downlink subframe received by the terminal device.

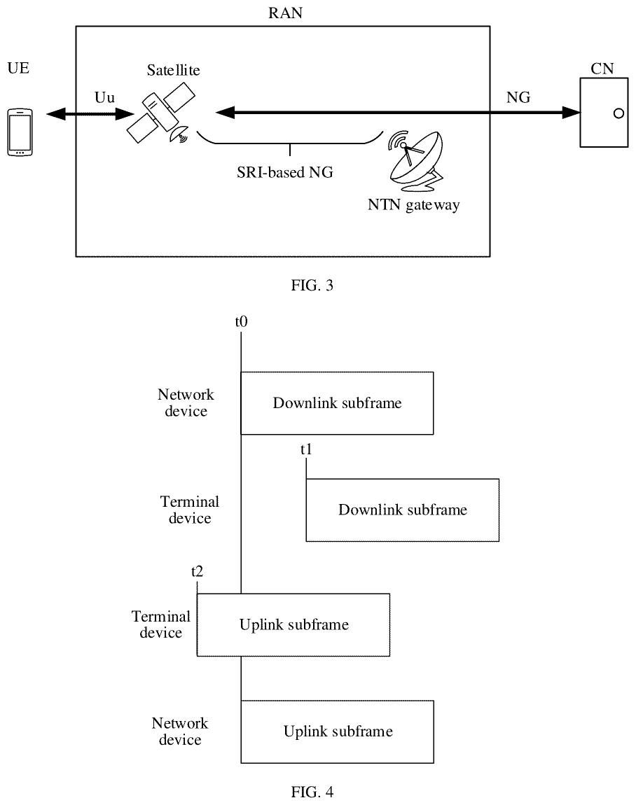

For example, as shown in FIG. 4, the network device sends a downlink subframe at a moment t0. Due to a transmission delay, the terminal device receives the downlink subframe at a moment t1. The network device schedules the terminal device to send an uplink subframe at the moment t0. Because the timing advance mechanism is used, the terminal device sends the uplink subframe at a moment t2, and the moment t2 is earlier than the moment t0 by duration Tp corresponding to the timing advance. Due to the transmission delay, the network device receives the uplink subframe from the terminal device at the moment t0. In this way, a start time point of the downlink subframe can be aligned with a start time point of the uplink subframe.

In a process in which the terminal device initially accesses the network device, the following steps or operations are included.

Step 1: The terminal device calculates a first TA, and sends a random access request to the network device based on the first TA.

Step 2: The network device performs TA estimation based on the random access request, to obtain a second TA; and the network device determines a TA adjustment value based on the first TA and the second TA, includes the TA adjustment value in a timing advance command (TAC) of a random access response (RAR), and indicates the TA adjustment value to the terminal device.

Step 3: The terminal device determines the TA adjustment value based on the TAC of the RAR, and adjusts the first TA based on the TA adjustment value, to obtain an adjusted first TA.

The terminal device sends an uplink message such as a message 3 by using the adjusted first TA.

In the foregoing process, due to an error, if the first TA calculated by the terminal device is excessively large, and consequently the timing advance is excessively large, the TA adjustment value determined by the network device may be a negative value. However, in a current mobile communication system, an indication of a negative TA adjustment value is not supported in an initial access procedure. When the negative TA occurs in the initial access procedure, performance of subsequent uplink data transmission is severely affected. Therefore, the embodiments provide a method, so that the terminal device can accurately calculate the first TA, and the TA adjustment value determined by the network device is a number greater than or equal to 0. In this way, a protocol requirement is met, occurrence of the negative TA is avoided, and system robustness is improved.

The network architecture and a service scenario described in embodiments are intended to describe the solutions in embodiments more clearly, and do not constitute a limitation on the solutions provided in the embodiments. A person of ordinary skill in the art may know that: With evolution of the network architecture and emergence of new service scenarios, the solutions provided in embodiments are also applicable to similar problems.

The method provided in the embodiments may be applied to the systems shown in FIG. 1 to FIG. 3. When a method procedure provided in the embodiments is applied to the system shown in FIG. 1, the first network device or the second network device in FIG. 1 may perform a method performed by the network device in the following procedure, and the terminal device in FIG. 1 may perform a method performed by the terminal device in the following procedure. When the method procedure provided in the embodiments is applied to the system shown in FIG. 2 or FIG. 3, the satellite or the base station in FIG. 2 or FIG. 3 may perform the method performed by the network device in the following procedure, and the terminal device in FIG. 2 or FIG. 3 may perform the method performed by the terminal device in the following procedure. It may be understood that a specific structure of an execution body of the method provided in embodiments is not limited in the following embodiments, provided that a program that records code of the method provided in embodiments can be run to perform communication according to the method provided in embodiments. For example, the execution body may be a terminal device or a functional module, for example, a chip, that can invoke and execute a program in the terminal device, or the execution body may be a network device or a functional module, for example, a chip, that can invoke and execute a program in the network device. In the following embodiments, only the terminal device or the network device is used as an example for description.

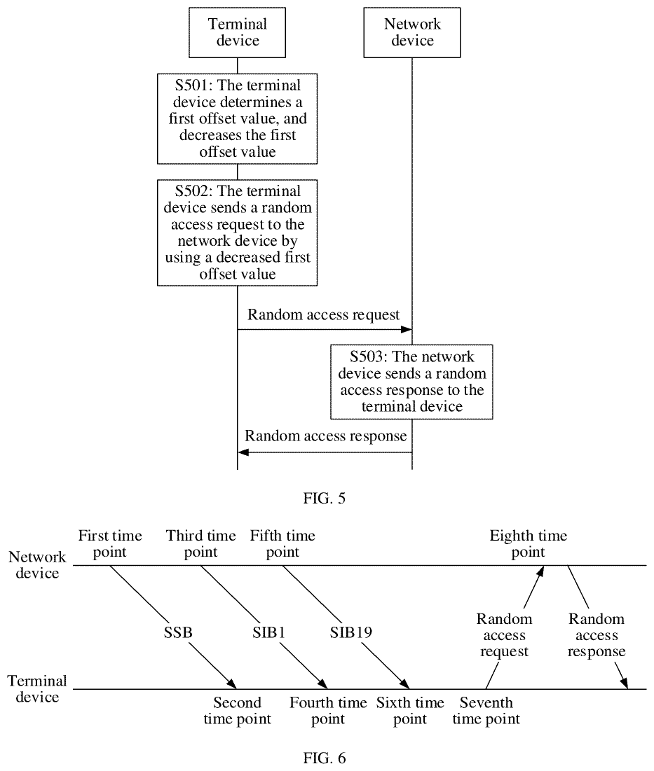

FIG. 5 is a schematic flowchart of a communication method according to an embodiment.

S501: A terminal device determines a first offset value, and decreases the first offset value.

In the embodiments, the first offset value is used to send a random access request in advance.

S502: The terminal device sends the random access request to a network device by using a decreased first offset value; and correspondingly, the network device receives the random access request from the terminal device.

A timing advance adjustment value indicated by a random access response corresponding to the random access request sent by using the decreased first offset value is greater than or equal to 0.

In an embodiment, the random access request may be a message 1 in a four-step random access procedure, and the message 1 may also be referred to as a preamble. In another embodiment, the random access request may be a message A in a two-step random access procedure, and the message A may include a preamble and data.

In the embodiments, the terminal device may send the random access request in advance by using the decreased first offset value. For example, the network device may send a system information block 1 (SIB1), and the SIB1 may indicate a random access channel occasion (RO). How the SIB1 indicates the RO is not limited. The RO is used to send the random access request, the RO may include a time-frequency resource used to carry the random access request, and a start time point of the RO may also be understood as a start time point of the time-frequency resource included in the RO. The terminal device may determine the random access channel occasion (RO) based on the SIB1, and the RO is used to send the random access request. It is assumed that the terminal device determines to send the random access request on a first RO, and a start moment of the first RO is a first moment. The terminal device may send the random access request in advance by the decreased first offset value. For example, the terminal device may send the random access request at a second moment before the first moment, and duration of an interval between the second moment and the first moment is the decreased first offset value.

In an embodiment, the terminal device may first determine the first offset value, and then decrease the first offset value.

In this embodiment, the first offset value determined by the terminal device may satisfy the following form:

$${T}_{TA} = ( {N}_{TA} + {N}_{TA , offset} + {N}_{TA , adj}^{com mon} + {N}_{TA , adj}^{UB} ) T \qquad ( 1 )$$

In this embodiment, the decreased first offset value may satisfy the following form:

$${T}_{TA 1} = {T}_{TA} - {N}_{offset} * T \qquad ( 2 )$$

T_{TA1} represents the decreased first offset value. N_{TA} is an uplink/downlink timing advance, and a value of N_{TA} is determined based on an indication of the network device, or if the network device does not indicate the value of N_{TA}, the value of N_{TA} is 0. For example, when the terminal device sends the random access request, the value of N_{TA} is 0. For an uplink message after the random access request, the network device may indicate the value of N_{TA} by using a TAC in the RAR, so that the terminal device may determine the value of N_{TA} based on the TAC.

N_{offset} is error information, and N_{offset} is greater than 0.

T represents a time unit, that is, a time unit of a communication system. For example, in an NR system, T may be T_{c}, and

$${T}_{c} = \frac{1}{Δ {f}_{max} \cdot {N}_{f}} \cdot Δ {f}_{max} = 480 \cdot {10}^{3} Hz ,$$

and N_{f}=4096. In an LTE system, T may be Tₛ, and

$${T}_{s} = \frac{1}{Δ {f}_{ref} \cdot {N}_{f , ref}} \cdot Δ {f}_{ref} = 15 \cdot {10}^{3} Hz ,$$

### and N_{f,ref}=2048.

N_{TA,offset} is a fixed offset used to determine the timing advance, and a value of N_{TA,offset} is a default value or a value indicated by the network device. For example, the value of N_{TA,offset} is determined based on an indication of the network device, or if the network device does not indicate the value of N_{TA,offset}, the value of N_{TA,offset} is the default value. For example, in an embodiment, the network device may indicate the value of N_{TA,offset} by using a parameter n-TimingAdvanceOffset; or if the network device does not indicate the value of N_{TA,offset} by using the parameter n-TimingAdvanceOffset, the value of N_{TA,offset} is a default value. For a specific value of the default value, refer to descriptions in a related protocol of the LTE system or the NR system. Details are not described herein again.

$${N}_{TA , adj}^{com mon}$$

is a timing correction amount controlled by a network side, and a value of

$${N}_{TA , adj}^{com mon}$$

is 0 or is a value indicated by the network device. For example, the value of

$${N}_{TA , adj}^{com mon}$$

is determined based on a higher-layer parameter configured on the network side, or if the higher-layer parameter is not configured on the network side, the value of

$${N}_{TA , adj}^{com mon}$$

is 0. For example, the network device may indicate the value of

$${N}_{TA , adj}^{com mon}$$

by using higher-layer parameters TA_{Common}, TA_{CommonDrift}, and TA_{CommonDriftVariation}, or if the network device does not indicate the value of

$${N}_{TA , adj}^{com mon} ,$$

the value of

$${N}_{TA , adj}^{com mon}$$

is 0. TA_{Common} indicates a common timing advance value controlled by the network, and may include any timing offset considered necessary by the network. TA_{CommonDrift} indicates a drift rate of a common TA. TA_{CommonDriftVariation} indicates a drift rate change of the common TA. The foregoing three higher-layer parameters may be carried in an NTN configuration sent by the network device, and the terminal device may determine the value of

$${N}_{TA , adj}^{com mon}$$

based on the foregoing three parameters. A specific determining process is not limited in the embodiments, and is not described herein again.

If ephemeris information of the network device is configured,

$${N}_{TA , adj}^{UE}$$

is determined based on position information of the terminal device and the ephemeris information of the network device, or if the ephemeris information of the network device is not configured, a value of

$${N}_{TA , adj}^{UE}$$

is 0.

For example, before S501, as shown in FIG. 6, the network device may send a synchronization signal/broadcast channel block (SSB). The SSB includes information such as system frame number information, and the SSB may further indicate information such as search space of the system information block 1 (SIB1). A time point at which the network device sends the SSB is a first time point, and a time point at which the terminal device receives the SSB is a second time point.

Before S501, as shown in FIG. 6, the network device may send the SIB1 and a SIB19. The SIB1 may indicate information such as system information of a cell, the RO, and scheduling information of the SIB19. The SIB19 may indicate information such as the ephemeris information of the network device. A time point at which the network device sends the SIB1 is a third time point, and a time point at which the terminal device receives the SIB1 is a fourth time point. A time point at which the network device sends the SIB19 is a fifth time point, and a time point at which the terminal device receives the SIB19 is a sixth time point.

In an embodiment, the ephemeris information may include a position vector of the network device at a reference time point and a speed vector of the network device at the reference time point. For example, the terminal device may determine the reference time point based on a system information (SI) time window in which the SIB19 carrying the ephemeris information is located. A specific process is not described again.

As shown in FIG. 6, a time point at which the terminal device sends the random access request is a seventh time point, and a time point at which the network device receives the random access request is an eighth time point. The network device may further send the random access response to the terminal device based on the random access request. For details, refer to descriptions of a random access procedure in the LTE system or the NR system. Details are not described herein again.

In the embodiments,

$${N}_{TA , adj}^{UE}$$

may be equal to a sum of synchronization signal (SS) timing and ephemeris timing.

For example, the terminal device may determine first position information of the network device at the first time point based on a system frame number of the SSB, a system frame number of the SIB1, and the ephemeris information of the network device. The terminal device may determine a delay between the first position information and second position information, where the delay is SS timing, and the second position information is position information of the terminal device at the second time point. The time point at which the network device receives the random access request is a time domain position of an RO resource used by the terminal device to send the random access request, so that the terminal device may determine third position information of the network device at the eighth time point based on the time domain position of the RO resource and the ephemeris information. The terminal device may determine a delay between the third position information and fourth position information, and the delay is ephemeris timing. The fourth position information is position information of the terminal device at the seventh time point.

In the embodiments, how to determine the error information is not limited. In an embodiment, a value of the error information N_{offset} is indicated by the network device.

In another embodiment, a value of the error information N_{offset} is determined by the terminal device.

If the error information is indicated by the network device, how the network device determines the value of the error information is not limited. Similarly, how the terminal device determines the value of the error information is not limited. For example, the network device or the terminal device may determine the error information in the following manner. For example, the error information is determined based on at least one of the following:
an ephemeris calculation error, an SS timing error, a positioning error, and an interpolation error.

For example, it is assumed that the ephemeris error is 1.4 μs, the SS timing error is 1.5 μs, the interpolation error is 0.04 μs, and the positioning error is 0.03 μs. In this case, the error information is 1.4+1.5+0.04+0.03=2.97 μs, that is, N_{offset}*T=2.97 μs.

The ephemeris calculation error is an error generated when position information of the network device is determined based on the ephemeris information of the network device. For example, the ephemeris calculation error may include at least one of the following: in a process of determining the SS timing, an error generated when the first position information of the network device when the network device sends the SSB is determined based on the ephemeris information of the network device; and in a process of determining the ephemeris timing, an error generated when the third position information of the network device when the network device receives the random access request is determined based on the ephemeris information of the network device.

For example, the terminal device obtains the ephemeris information of the network device from the SIB19, and the terminal device may estimate the first position information of the network device at the first time point based on the ephemeris information, the reference time point corresponding to the ephemeris information, and the first time point at which the network device sends the SSB. An error exists in a process in which the terminal device estimates the first position information. The error may be used as a part of the ephemeris calculation error.

The SS timing error is an error generated when the synchronization signal timing between the terminal device and the network device is determined based on the position information of the terminal device and the ephemeris information of the network device, or may be understood as an error generated when a delay between the terminal device and the network device is determined based on the position information of the terminal device and the ephemeris information of the network device. For example, an error generated in a process in which the terminal device determines, based on the ephemeris information, the first position information of the network device when the network device sends the SSB, and determines the SS timing based on the first position information and the second position information when the terminal device receives the SSB is the SS timing error. The SS timing error may also be referred to as a timing error.

For example, in a process of calculating the SS timing, an error that may be introduced includes at least one of the following: a time deviation error

$$Δ {T}_{d}^{ueVel}$$

caused by a speed of the terminal device and rotation of the earth, an error

$$Δ {T}_{d}^{model}$$

introduced by a calculation model for calculating an ephemeris, and an error

$$Δ {T}_{d}^{UTC}$$

introduced by a universal time coordinated (UTC) precision.

With reference to the foregoing descriptions, for example, the SS timing Ta may satisfy the following form:

$${T}_{d} = {T}_{d}^{dis} + Δ {T}_{d}^{ueVel} + Δ {T}_{d}^{model} + Δ {T}_{d}^{UTC} \qquad ( 3 )$$

$${T}_{d}^{dis}$$

may be obtained by dividing a speed of an electromagnetic wave by a distance between the first position information and the second position information.

The positioning error is an error generated when the position information of the terminal device is determined. For example, an error generated in a process in which the terminal device determines the position information of the terminal device based on a global navigation satellite system (GNSS) is the positioning error.

The interpolation error is an error generated when the position information of the terminal device and/or the ephemeris information of the network device are/is calculated in an interpolation manner. For example, the interpolation error is an additional error introduced into a process of calculating the position information of the terminal device and/or the ephemeris information of the network device through extrapolation and interpolation. The terminal device does not calculate the ephemeris information of the network device or the position information of the terminal device in each transmission time interval (TTI). In a part of TTIs, the terminal device determines the ephemeris information of the network device and the position information of the terminal device through sampling point extrapolation and interpolation. For example, in a first TTI and a third TTI, the terminal device separately calculates ephemeris information of the network device and position information of the terminal device. In a second TTI between the first TTI and the third TTI, the terminal device may perform interpolation deduction based on the ephemeris information calculated in the first TTI and the ephemeris information calculated in the third TTI, to obtain ephemeris information in the second TTI. Similarly, the terminal device may perform interpolation deduction based on the position information calculated in the first TTI and the position information calculated in the third TTI, to obtain position information in the second TTI.

In the embodiments, specific values of the ephemeris calculation error, the SS timing error, the positioning error, and the interpolation error are determined based on a plurality of factors. During actual application, one value may be preset for each of the foregoing errors, a value of each of the foregoing errors is determined based on a plurality of experiments, or the value of each of the foregoing errors may be determined in another manner. This is not limited.

In another embodiment, the terminal device directly determines the decreased first offset value. In other words, the terminal device does not first determine the first offset value, and then decreases the first offset value.

In this embodiment, the decreased first offset value determined by the terminal device may satisfy the following form:

$${T}_{TA 1} = ( {N}_{TA} + {N}_{TA , offset} + {N}_{TA , adj}^{common} + {N}_{TA , adj}^{UE} - {N}_{offset} ) T \qquad ( 4 )$$

Alternatively, the decreased first offset value determined by the terminal device may satisfy the following form:

$${T}_{TA 1} = ( {N}_{TA} + {N}_{TA , offset} + {N}_{TA , adj}^{common} + {N}_{TA , adj 2}^{UE} ) T \qquad ( 5 )$$

In this embodiment, the terminal device may directly determine the decreased first offset value according to the formula (4) or the formula (5).

$${N}_{TA , adj 2}^{UE}$$

is determined based on position information of the terminal device, ephemeris information of the network device, and error information. For meanings of other parameters in the formula (4) and the formula (5), refer to the descriptions in the formula (1) and the formula (2). Details are not described herein again.

In an embodiment,

$${N}_{TA , adj 2}^{UE}$$

may satisfy the following form:

$${N}_{TA , adj 2}^{UE} = {N}_{TA , adj}^{UE} - {N}_{offset} \qquad ( 6 )$$

In an embodiment,

$${N}_{TA , adj 2}^{UE}$$

may satisfy the following form:

$${N}_{TA , adj 2}^{UE} = {N}_{TA , adj}^{UE} - b \qquad ( 7 )$$

In an embodiment,

$${N}_{TA , adj 2}^{UE}$$

may satisfy the following form:

$${N}_{TA , adj 2}^{UE} = {N}_{TA , adj}^{UE} \times δ \qquad ( 8 )$$

For meanings of T and

$${N}_{TA , adj}^{UE} ,$$

refer to the descriptions in the formula (1). For meanings of N_{offset}, refer to the descriptions in the formula (2). Details are not described herein again. b is greater than 0, and δ is greater than 0 and less than 1.

In an embodiment, b and δ are determined based on the error information. For example, a value of b is any value in a value range [0, N_{offset}]. For example, a value of δ is any value in a value range

$$[ 0 , 1 - {N}_{offset} / {N}_{TA , adj}^{UE} ] .$$

S503: The network device sends the random access response to the terminal device; and correspondingly, the terminal device receives the random access response from the network device.

In a possible embodiment, the random access response includes the timing advance adjustment value. For example, the network device may include a timing advance command (TAC) in the random access response, and the TAC indicates the timing advance adjustment value. In this embodiment, the timing advance adjustment value may be used to adjust the decreased first offset value. How the network device determines the timing advance adjustment value indicated by the TAC is not limited.

In the embodiments, the timing advance adjustment value may be used to determine a timing advance, and the timing advance is used by the terminal device to send an uplink message.

In a possible embodiment, the terminal device determines the timing advance based on the timing advance adjustment value and the decreased first offset value. For example, the terminal device may use, as the timing advance, a difference obtained by subtracting the timing advance adjustment value from the decreased first offset value.

The terminal device may send the uplink message to the network device based on the timing advance. For example, the terminal device may send a message such as a message 3 in the four-step random access procedure to the network device based on the timing advance.

According to the method provided in the embodiments, the decreased first offset value determined by the terminal device is less than the existing first offset value. For example, the decreased first offset value is obtained by subtracting a value from the first offset value or multiplying the first offset value by a coefficient greater than 0 and less than 1. Therefore, when the terminal device sends the random access request by using the decreased first offset value, the first offset value may be prevented from being excessively large. In this way, the timing advance adjustment value obtained by the network device based on the decreased first offset value may be large, and a case in which the timing advance adjustment value obtained by the network device based on the first offset value is a negative value is avoided.

In the embodiments, when determining an offset value used to send the random access request in advance, the terminal device may also consider the error information, to improve accuracy of the determined offset value. In a process of determining the offset value, the terminal device expects to determine a small offset value, so that the TA adjustment value in the RAR is a number greater than or equal to 0. For details, refer to descriptions in the following procedure.

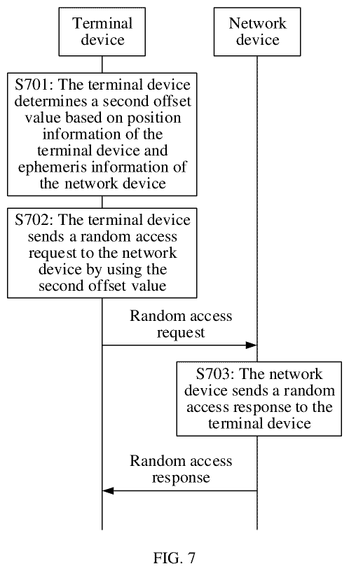

FIG. 7 is a schematic flowchart of a communication method according to an embodiment.

S701: A terminal device determines a second offset value based on position information of the terminal device and ephemeris information of a network device.

In an embodiment, the terminal device determines the second offset value based on the position information of the terminal device, the ephemeris information of the network device, and error information. The error information is determined based on at least one of an ephemeris calculation error, a synchronization signal timing error, a positioning error, and an interpolation error. For meanings of the error information, the ephemeris calculation error, the synchronization signal timing error, the positioning error, and the interpolation error, refer to the descriptions in S502. Details are not described herein again.

In the embodiments, the second offset value is used to send a random access request in advance.

In an embodiment, the second offset value may satisfy the following form:

$${T}_{TA 2} = ( {N}_{TA} + {N}_{TA , offset} + {N}_{TA , adj}^{common} + {N}_{TA , adj}^{UE} - {N}_{offset} ) T \qquad ( 9 )$$

In an embodiment, the second offset value may satisfy the following form:

$${T}_{TA 2} = ( {N}_{TA} + {N}_{TA , offset} + {N}_{TA , adj}^{common} + {N}_{TA , adj 2}^{UE} ) T \qquad ( 10 )$$

T_{TA2} represents the second offset value. N_{TA} is an uplink/downlink timing advance, and a value of N_{TA} is determined based on an indication of the network device, or if the network device does not indicate the value of N_{TA}, the value of N_{TA} is 0. For example, when the terminal device sends the random access request, the value of N_{TA} is 0. For an uplink message after the random access request, the network device may indicate the value of N_{TA} by using a TAC in a random access response, so that the terminal device may determine the value of N_{TA} based on the TAC.

N_{offset} is the error information, and N_{offset} is greater than 0. How to determine the error information is not limited. In an embodiment, a value of the error information N_{offset} is indicated by the network device. In another embodiment, a value of the error information N_{offset} is determined by the terminal device. For example, the network device or the terminal device may determine the error information in the following manner. For example, the error information is determined based on at least one of the following:
the ephemeris calculation error, the SS timing error, the positioning error, and the interpolation error.

For specific content of the error information, refer to the descriptions in step 502. Details are not described herein again.

T represents a time unit, that is, a time unit of a communication system. A value of N_{TA,offset} is a default value or a value indicated by the network device. For example, the value of N_{TA,offset} is determined based on an indication of the network device, or if the network device does not indicate the value of N_{TA,offset}, the value of N_{TA,offset} is the default value.

$${N}_{TA , adj}^{c o m m o n}$$

is a timing correction amount controlled by a network side, and a value of

$${N}_{TA , adj}^{c o m m o n}$$

is 0 or is a value indicated by the network device. For example, the value of

$${N}_{TA , adj}^{c o m m o n}$$

is determined based on a higher-layer parameter configured on the network side, or if the higher-layer parameter is not configured on the network side, the value of

$${N}_{TA , adj}^{c o m m o n}$$

is 0.

If the ephemeris information of the network device is configured,

$${N}_{TA , adj}^{UE}$$

is determined based on the position information of the terminal device and the ephemeris information of the network device, or if the ephemeris information of the network device is not configured, a value of

$${N}_{TA , adj}^{UE}$$

is 0.

$${N}_{TA , adj 2}^{UE}$$

is a timing correction amount derived by the terminal device. If the ephemeris information of the network device is configured,

$${N}_{TA , adj 2}^{UE}$$

is calculated based on the position information of the terminal device and the ephemeris information of the network device, or if the ephemeris information of the network device is not configured, a value of

$${N}_{TA , adj 2}^{UE}$$

is 0. For example,

$${N}_{TA , adj 2}^{UE}$$

may be determined according to any one of a formula (6) to a formula (8).

For meanings of other parameters in the formula (9) and the formula (10), refer to the descriptions in the formula (1) to the formula (5). Details are not described herein again.

In an embodiment, the terminal device does not expect that the determined

$${N}_{TA , adj 2}^{UE}$$

causes a TA adjustment value indicated by the random access response to be set to a negative number. Alternatively, the terminal device expects that the determined

$${N}_{TA , adj 2}^{UE}$$

causes a TA adjustment value indicated by the random access response to be set to a number greater than or equal to 0.

In an embodiment, in an initial access phase, the terminal device determines T_{TA2} based on

$${N}_{TA , adj 2}^{UE}$$

that is calculated, and sends a PRACH in advance by using T_{TA2}. The terminal device expects that after the PRACH is sent by using T_{TA2}, the TA adjustment value received in the random access response is greater than or equal to 0. Herein, “sending the PRACH” may be replaced with “sending the random access request”.

In an embodiment, in an initial access phase, the terminal device determines T_{TA2} based on

$${N}_{TA , adj 2}^{UE}$$

that is calculated, and sends a PRACH in advance by using T_{TA2}. The terminal device does not expect that after the PRACH is sent by using T_{TA2}, the TA adjustment value received in the random access response is less than 0. Herein, “sending the PRACH” may be replaced with “sending the random access request”.

S702: The terminal device sends the random access request to the network device by using the second offset value; and correspondingly, the network device receives the random access request from the terminal device.

In an embodiment, the random access request may be a message 1 in a four-step random access procedure, and the message 1 may also be referred to as a preamble. In another embodiment, the random access request may be a message A in a two-step random access procedure, and the message A may include a preamble and data.

In the embodiments, the terminal device may send the random access request in advance by using the second offset value. For example, the terminal device determines to send the random access request on a first RO, and a start moment of the first RO is a first moment. The terminal device may send the random access request in advance by the second offset value. For example, the terminal device may send the random access request at a third moment before the first moment, and duration of an interval between the third moment and the first moment is the second offset value.

S703: The network device sends the random access response to the terminal device; and correspondingly, the terminal device receives the random access response from the network device.

In a possible embodiment, the random access response may indicate the timing advance adjustment value, and the timing advance adjustment value indicated by the random access response is not less than 0. In other words, the timing advance adjustment value indicated by the random access response is greater than or equal to 0. For example, the random access response includes the TAC, and the TAC indicates the timing advance adjustment value.

In the embodiments, the timing advance adjustment value may be used to determine a timing advance, and the timing advance is used by the terminal device to send an uplink message.

In a possible embodiment, the terminal device determines the timing advance based on the timing advance adjustment value and the second offset value. For example, the terminal device may use, as the timing advance, a difference obtained by subtracting the timing advance adjustment value from the second offset value.

In a possible embodiment, the terminal device may determine the timing advance based on the timing advance adjustment value indicated by the random access response, and send the uplink message based on the timing advance. For example, the terminal device may send a message such as a message 3 in the four-step random access procedure to the network device based on the timing advance.

According to the method provided in the embodiments, factors such as the error information are considered for the second offset value determined by the terminal device, to improve accuracy of the second offset value. Further, the second offset value for which the factors such as the error information are considered is less than an existing offset value. Therefore, when the terminal device sends the random access request by using the second offset value, the timing advance adjustment value obtained by the network device based on the second offset value may be large (for example, may be greater than or equal to 0), and a case in which the timing advance adjustment value is a negative value is avoided.

In the embodiments, the network device may alternatively indicate a timing advance less than 0. For details about how to indicate the timing advance, refer to descriptions in the following procedure.

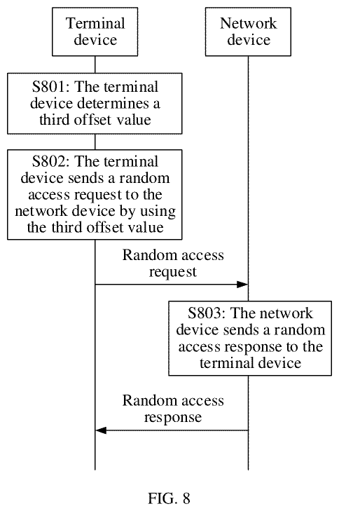

FIG. 8 is a schematic flowchart of a communication method according to an embodiment.

S801: A terminal device determines a third offset value.

In the embodiments, the third offset value is used to send a random access request in advance. The third offset value may satisfy the formula (1). For example, the third offset value is the first offset value T_{TA} in the formula (1). For details, refer to the descriptions in the formula (1). Details are not described herein again.

S802: The terminal device sends the random access request to a network device by using the third offset value; and correspondingly, the network device receives the random access request from the terminal device.

In an embodiment, the random access request may be a message 1 in a four-step random access procedure, and the message 1 may also be referred to as a preamble. In another embodiment, the random access request may be a message A in a two-step random access procedure, and the message A may include a preamble and data.

S803: The network device sends a random access response to the terminal device; and correspondingly, the terminal device receives the random access response from the network device.

In a possible embodiment, the random access response indicates a timing advance adjustment value. For example, the network device may include a TAC in the random access response, and the TAC indicates the timing advance adjustment value. The timing advance adjustment value is used to determine a timing advance.

In S803, the timing advance N_{TA} determined by the terminal device based on the timing advance adjustment value may be greater than or equal to 0, or may be less than 0. When the timing advance is less than 0, it indicates that the terminal device delays sending uplink data or an uplink message by time corresponding to the timing advance.

Embodiment 1: A quantity of bits for indicating the timing advance adjustment value is increased, and an indication range of the timing advance adjustment value is extended to a negative number. For example, a value range of the timing advance adjustment value is: −3846, . . . , −1, 0, 1, 2, . . . , and 3846, that is, [−3846, 3846].

Embodiment 2: A quantity of indication bits for indicating the timing advance adjustment value remains unchanged, and a bit R is added to indicate a positive or negative indication of the timing advance adjustment value. If the bit R=0, it indicates that a value of the timing advance adjustment value is a value greater than or equal to 0, or if the bit R=1, it indicates that the value of the timing advance adjustment value is a value less than or equal to 0.

Embodiment 3: A formula for calculating the timing advance N_{TA} is changed to N_{TA}=a*T_{A}*16*64/2^{μ}, where T_{A} represents the timing advance adjustment value. a={1, −1}. A specific value is indicated by using signaling of the network device, and 1 bit is used to select and indicate one of candidate values of a.

Embodiment 4: A quantity of bits for indicating the timing advance adjustment value is not increased, and an indication range of the timing advance adjustment value is extended to a negative number. For example, an original value range of the timing advance adjustment value is 0, 1, 2, . . . , and 3846. A value range of the timing advance adjustment value extended to a negative number is: −1923, . . . , −1, 0, 1, 2, . . . , and 1923, that is, [−1923, 1923] .

In the foregoing method, the TAC indication range is extended, the TAC calculation formula is changed, or the positive or negative number indication is added to the TAC, so that the network device supports an indication of a negative timing advance adjustment value in the RAR. In this way, a negative timing advance can be indicated, and a network side can flexibly adjust the TAC indication range in the RAR based on a PRACH estimation result. This ensures that on the network side, a sending time sequence of a message 3 can be aligned, and the message 3 can be received and demodulated, to ensure initial access performance.

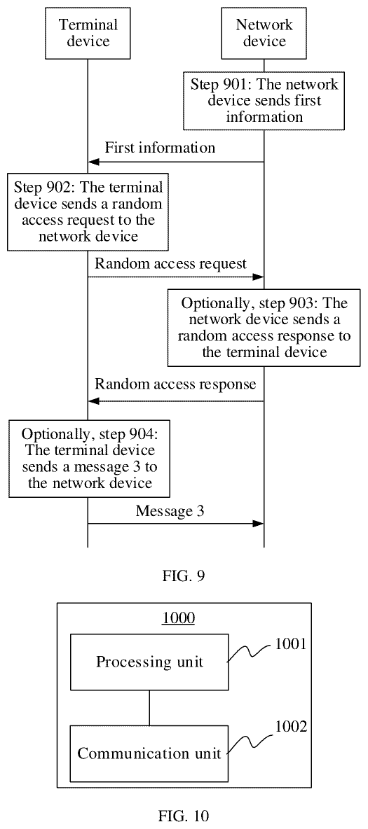

FIG. 9 is a schematic flowchart of a communication method according to an embodiment.

Step 901: A network device sends first information, where the first information indicates a first value.

Correspondingly, a terminal device receives the first information from the network device.

The first value, N_{TA}, N_{TA,offset},

$${N}_{TA , adj}^{common} , and {N}_{TA , adj}^{UE}$$

are used to determine a sending time point of an uplink message, for example, may be used to determine a sending time point of a random access request.

How the network device sends the first information is not limited. For example, the network device sends an SSB, and the SSB includes the first information. Alternatively, the network device sends system information, and the system information includes the first information. The system information includes, but is not limited to, cell-level common information such as a SIB1, a SIB19, or other system information (OSI).

In the embodiments, a value of N_{TA} is determined based on an indication of the network device, or if the network device does not indicate the value of N_{TA}, the value of N_{TA} is 0. For example, the network device may indicate the value of N_{TA} by using a TAC. How the network device indicates the value of N_{TA} is not limited. For example, refer to the descriptions in S502. An example is not described herein again. For another example, before the terminal device sends the random access request, the network device does not indicate the value of N_{TA}, and the value of N_{TA} is 0. For an uplink message after the random access request, the network device may indicate the value of N_{TA} by using a random access response, so that the terminal device may determine the value of N_{TA}.

A value of N_{TA,offset} is determined based on an indication of the network device, or if the network device does not indicate the value of N_{TA,offset}, the value of N_{TA,offset} is a default value. For example, the default value of N_{TA,offset} is provided in 3GPP technical specification (TS) 38.133. How the network device indicates the value of N_{TA,offset} is not limited. For example, the network device indicates the value of N_{TA,offset} by using a parameter n-timing advance offset (n-TimingAdvanceOffset).

A value of

$${N}_{TA , adj}^{common}$$

is determined based on a higher-layer parameter configured on a network side, or if the higher-layer parameter is not configured on the network side, the value of

$${N}_{TA , adj}^{common}$$

is 0. How the network indicates the value of

$${N}_{TA , adj}^{common}$$

is not limited. For example, if the network device configures higher-layer parameters TA_{Common}, TA_{CommonDrift}, and TA_{CommonDriftVariation}, the value of

$${N}_{TA , adj}^{common}$$

may be determined based on the foregoing three higher-layer parameters. For the foregoing three higher-layer parameters, refer to the descriptions in S502, or refer to related descriptions in 3GPP TS 38.331. This is not limited.

For example, Delay_{common}(t) is calculated based on the foregoing three higher-layer parameters according to the following formula:

$${Delay}_{common} ( t ) = \frac{1}{2} [ \text{} {TA}_{Common} + {TA}_{CommonDrift} \times ( t - {t}_{epoch} ) + {TA}_{CommonDriftVariation} \times {( t - {t}_{epoch} )}^{2} ] .$$

A one-way propagation delay Delay_{common}(t) calculated according to the foregoing formula is the value of

$${N}_{TA , adj}^{common} .$$

For example, Delay_{common}(t) may be understood as: at a time point t, a distance between a satellite and an uplink time synchronization reference point divided by a speed of light. The satellite may be a network device that provides a service for the terminal device. t_{epoch} is epoch time of the higher-layer parameters TA_{Common}, TA_{CommonDrift}, and TA_{CommonDriftVariation}. Optionally, the uplink time synchronization reference point is a point at which a downlink (DL) and an uplink (UL) are frame aligned with an offset given by N_{TA,offset}.

If ephemeris information of the network device is configured,

$${N}_{TA , adj}^{UE}$$

is determined based on position information of the terminal device and the ephemeris information of the network device, or if the ephemeris information of the network device is not configured, a value of

$${N}_{TA , adj}^{UE}$$

is 0. For example, how to determine the value of

$${N}_{TA , adj}^{UE}$$

based on the position information of the terminal device and the ephemeris information of the network device is not limited. For example, refer to related descriptions in 3GPP TS 38.331, or refer to the descriptions in S502. Details are not described herein again.

In the embodiments, the first value may be greater than or equal to 0. How the network device determines the first value is not limited. For example, the network device may determine the first value based on at least one of the following:
an ephemeris calculation error, an SS timing error or a timing error, a positioning error, and an interpolation error, where for meanings of the foregoing parameters, refer to the descriptions in S502, and details are not described herein again.

For example, it is assumed that the ephemeris error is 1.4 μs, the SS timing error is 1.5 μs, the interpolation error is 0.04 μs, and the positioning error is 0.03 μs. In this case, the first value is equal to 1.4+1.5+0.04+0.03=2.97 μs.

Optionally, the network device may alternatively determine the first value based on a capability of the terminal device. For example, the network device may send a list including {UE capability, offset value}. The list may include at least one UE capability and an offset value corresponding to each UE capability. For example, the list may include {UE capability 1, offset value 1} and {UE capability 2, offset value 2}. If the capability of the terminal device is the UE capability 1, the first value is the offset value 1. If the capability of the terminal device is the UE capability 2, the first value is the offset value 2. For example, for a terminal device with a strong capability, if an ephemeris error, a positioning error, a timing error, an interpolation error, and the like that are calculated are all small, a total error is small, and the network device may deliver a small first value. For a terminal device with a weak capability, if an ephemeris error, a positioning error, a timing error, an interpolation error, and the like that are calculated are large, a total error is large, and the network device may deliver a large first value. In this way, a problem of occurrence of a negative TA can be avoided.

In the embodiments, the first information may directly indicate the first value. For example, the first information includes a specific value of the first value. The terminal device may directly determine the first value based on the first information.

The first information may alternatively indirectly indicate the first value. For example, the first information includes at least one of the ephemeris calculation error, the SS timing error, the positioning error, and the interpolation error, and the terminal device may determine the first value based on content in the first information. Alternatively, the first value corresponds to one index, the first information includes the index corresponding to the first value, and the terminal device may determine the first value based on the index.

The foregoing is merely an example. How the first information indicates the first value is not limited.

Step 902: The terminal device sends the random access request to the network device.

The random access request is used to initiate random access, and the sending time point of the random access request is determined based on the first value.

Correspondingly, the network device receives the random access request from the terminal device.

In the embodiments, there may be a plurality of embodiments of how the terminal device determines the sending time point of the random access request based on the first value, N_{TA}, N_{TA,offset},

$${N}_{TA , adj}^{common} , and {N}_{TA , adj}^{UE} .$$

The following provides several examples.

Embodiment 1: The sending time point T_{TX1} of the random access request satisfies the following form:

$${T}_{TX 1} = {T}_{TX 2} - {T}_{TA 3} \qquad ( 11 )$$

T_{TA3} is determined based on the first value N_{offset2}, and T_{TA3} may also be referred to as a fourth offset value. A specific name of T_{TA3} is not limited. T_{TX2} represents a start time point of an RO corresponding to the random access request.

T_{TA3} satisfies the following form:

$${T}_{TA 3} = ( {N}_{TA} + {N}_{TA , offset} + {N}_{TA , adj}^{common} + {N}_{TA , adj}^{UE} - {N}_{offset 2} ) T , \qquad ( 12 )$$

where the first value N_{offset2} is greater than 0; or

$${T}_{TA 3} = ( {N}_{TA} + {N}_{TA , offset} + {N}_{TA , adj}^{common} + {N}_{TA , adj}^{UE} + {N}_{offset 2} ) T , \qquad ( 13 )$$

where the first value N_{offset2} is less than 0.

T represents a time unit, that is, a time unit of a communication system. For example, in an NR system, T may be T_{c}, and

$${T}_{c} = \frac{1}{Δ {f}_{max} \cdot {N}_{f}} .$$

$$Δ {f}_{max} = 480 \cdot {10}^{3} Hz ,$$

and N_{f}=4096. In an LTE system, T may be Tₛ, and

$${T}_{s} = \frac{1}{Δ {f}_{ref} \cdot {N}_{f , ref}} .$$

$$Δ {f}_{ref} = 15 \cdot {10}^{3} Hz ,$$

### and N_{f,ref}=2048.

In this embodiment, the network device may send a SIB1, and the SIB1 may indicate the RO. How the SIB1 indicates the RO is not limited. The RO corresponding to the random access request may be understood as that the random access request is correspondingly transmitted on the RO. The RO is used to send the random access request, the RO may include a time-frequency resource used to carry the random access request, and the start time point of the RO may also be understood as a start time point of the time-frequency resource included in the RO. Correspondingly, the terminal device may determine the RO based on the SIB1.

Embodiment 2: The sending time point T_{TX1} of the random access request satisfies the following form:

$${T}_{TX 1} = {T}_{TX 2} - ( {T}_{TA} - {N}_{offset 2} ) ; or \qquad ( 14 )$$

$${T}_{TX 1} = {T}_{TX 2} - ( {T}_{TA} - {N}_{offset 2} \times T ) \qquad ( 15 )$$

N_{offset2} represents the first value, the first value is greater than 0, T_{TA} represents a first offset value, T_{TX2} represents a start time point of an RO corresponding to the random access request, and T represents a time unit.

Alternatively, the sending time point T_{TX1} of the random access request satisfies the following form:

$${T}_{TX 1} = {T}_{TX 2} - ( {T}_{TA} + {N}_{offset 2} ) ; or \qquad ( 16 )$$

$${T}_{TX 1} = {T}_{TX 2} - ( {T}_{TA} + {N}_{offset 2} \times T ) \qquad ( 17 )$$

N_{offset2} represents the first value, the first value is less than 0, T_{TA} represents a first offset value, T_{TX2} represents a start time point of an RO corresponding to the random access request, and T represents a time unit.

In Embodiment 2, the first offset value T_{TA} may satisfy the following form:

$${T}_{TA} = ( {N}_{TA} + {N}_{TA , offset} + {N}_{TA , adj}^{common} + {N}_{TA , adj}^{UE} ) T \qquad ( 18 )$$

For meanings of the foregoing parameters, refer to the descriptions of the parameters included in the formula (1) in S502. Details are not described herein again.

Optionally, step 903: The network device sends the random access response to the terminal device.

Correspondingly, the terminal device receives the random access response from the network device. The random access response is a message in response to the random access request.

In a possible embodiment, the random access response includes a timing advance adjustment value. Optionally, the timing advance adjustment value is greater than or equal to 0. For example, the network device may include a TAC in the random access response, and the TAC indicates the timing advance adjustment value. The timing advance adjustment value may be used to determine a timing advance, and the timing advance is used by the terminal device to send the uplink message. How the network device indicates the timing advance adjustment value is not limited.

Correspondingly, the terminal device determines the timing advance based on the timing advance adjustment value. For example, in a first embodiment, the terminal device may use, as the timing advance, a difference obtained by subtracting the timing advance adjustment value from the fourth offset value T_{TA3}. That is, the timing advance T_{TA4} may satisfy the following form:

$${T}_{TA 4} = {T}_{TA 3} - {N}_{TA} \qquad ( 19 )$$

N_{TA} represents the timing advance adjustment value.

In a second embodiment, the terminal device may determine the timing advance based on the timing advance adjustment value, the first offset value, and the first value. For example, the timing advance T_{TA4} may satisfy the following form:

$${T}_{TA 4} = ( {T}_{TA} - {N}_{offset 2} ) - {N}_{TA} , \qquad ( 20 )$$

where the first value N_{offset2} is greater than 0; or

$${T}_{TA 4} = ( {T}_{TA} + {N}_{offset 2} ) - {N}_{TA} , \qquad ( 21 )$$

where the first value N_{offset2} is less than 0.

The foregoing is merely an example. There may further be another manner of determining the timing advance, and details are not described herein again.

Optionally, step 904: The terminal device sends a message 3 to the network device.

Correspondingly, the network device receives the message 3. The message 3 may be a message 3 in a four-step random access procedure. The message 3 may alternatively be an RRC setup request (RRCSetupRequest) message in an RRC setup process. The message 3 may alternatively be an RRC resume request (RRCResumeRequest) message in an RRC resume process, or an RRC reestablishment request (RRCReestablishmentRequest) message in an RRC reestablishment process.

The terminal device may send the message 3 based on the timing advance. For example, the terminal device may determine a sending time point of the message 3 based on the timing advance.

Alternatively, the terminal device may send, based on the timing advance, a sending time point of another uplink message to the network device. Examples are not described herein one by one.

After step 904, there may be another message. For example, the network device sends a message 4. This is not limited, and examples are not described one by one.

Currently, because the sending time point of the random access request is estimated by the terminal device, the random access request may be sent prematurely or excessively late, and alignment cannot be implemented with the network side. As a result, data demodulation fails, and access performance is affected. However, according to the foregoing method, the network device indicates the first value to the terminal device, and when sending the random access request, the terminal device may determine the sending time point of the random access request based on the first value, so that the terminal device can accurately determine the sending time point of the random access request, and the sending time point of the random access request can be aligned with the network side, to increase a data demodulation success rate on the network side and improve access performance.

In the foregoing embodiments, the methods provided in embodiments are separately described from a perspective of interaction between devices. To implement functions in the methods provided in the foregoing embodiments, the network device or the terminal device may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the solutions.

In embodiments, division into modules is an example, and is merely logical function division. During actual implementation, there may be another division manner. In addition, functional modules in embodiments may be integrated into one processor, or may exist alone physically, or two or more modules may be integrated into one module. The integrated module may be implemented in a form of hardware, or may be implemented in a form of a software functional module.

Same as the foregoing concept, as shown in FIG. 10, an embodiment further provides a communication apparatus 1000, configured to implement functions of the network device or the terminal device in the foregoing methods. For example, the communication apparatus may be a software module or a chip system. In this embodiment, the chip system may include a chip, or may include a chip and another discrete component. The communication apparatus 1000 may include a processing unit 1001 and a communication unit 1002.

In this embodiment, the communication unit may also be referred to as a transceiver unit, and may include a sending unit and/or a receiving unit, which are respectively configured to perform sending and receiving steps performed by the network device or the terminal device in the foregoing method embodiments.

The following describes in detail communication apparatuses provided in embodiments with reference to FIG. 10 to FIG. 12. It should be understood that descriptions of apparatus embodiments correspond to the descriptions of the method embodiments. Therefore, for content that is not described in detail, refer to the foregoing method embodiments. For brevity, details are not described herein again.

The communication unit may also be referred to as a transceiver, a transceiver machine, a transceiver apparatus, or the like. The processing unit may also be referred to as a processor, a processing board, a processing module, a processing apparatus, or the like. The communication unit may also include the sending unit and the receiving unit. The sending unit may also be sometimes referred to as a transmitter machine, a transmitter, a transmitter circuit, or the like. The receiving unit may also be sometimes referred to as a receiver machine, a receiver, a receiver circuit, or the like. The sending unit and the receiving unit may be one integrated unit, or may be two independent units.

In an embodiment, the communication apparatus 1000 may perform the following functions.

The processing unit is configured to: determine a first offset value, and decrease the first offset value, where the first offset value is used to send a random access request in advance.

The communication unit is configured to: send the random access request to the network device by using a decreased first offset value, where a timing advance adjustment value indicated by a random access response corresponding to the random access request sent by using the decreased first offset value is greater than or equal to 0; and receive the random access response from the network device.

In an embodiment, the communication apparatus 1000 may perform the following functions.

The communication unit is configured to receive a random access request from the terminal device, where the random access request is sent by using a decreased first offset value, and the first offset value is used to send the random access request in advance.

The processing unit is configured to send a random access response to the terminal device based on the random access request through the communication unit, where a timing advance adjustment value indicated by the random access response is greater than or equal to 0.

In an embodiment, the communication apparatus 1000 may perform the following functions.

The processing unit is configured to determine a second offset value based on position information of the terminal device and ephemeris information of the network device.

The communication unit is configured to: send a random access request to the network device by using the second offset value, and receive a random access response from the network device, where a timing advance adjustment value indicated by the random access response is not less than 0, or the timing advance adjustment value indicated by the random access response is greater than or equal to 0.

In an embodiment, the communication apparatus 1000 may perform the following functions.

The processing unit is configured to determine a second offset value based on position information of the terminal device, ephemeris information of the network device, and error information, where the error information is determined based on at least one of an ephemeris calculation error, a synchronization signal timing error, a positioning error, and an interpolation error.

The communication unit is configured to send a random access request to the network device by using the second offset value.

In an embodiment, the communication apparatus 1000 may perform the following functions.

The communication unit is configured to receive a random access request from the terminal device, where the random access request is sent by using a second offset value, the second offset value is determined based on position information of the terminal device, ephemeris information of the network device, and error information, and the error information is determined based on at least one of an ephemeris calculation error, a synchronization signal timing error, a positioning error, and an interpolation error.

The processing unit is configured to send a random access response to the terminal device based on the random access request through the communication unit.

In an embodiment, the communication apparatus 1000 may perform the following functions.

The processing unit is configured to receive first information from the network device through the communication unit, where the first information indicates a first value.

The processing unit is configured to send a random access request to the network device through the communication unit, where a sending time point of the random access request is determined based on the first value, N_{TA}, N_{TA,offset},

$${N}_{TA , adj}^{common} , and {N}_{TA , adj}^{UE} ;$$

a value of N_{TA} is determined based on an indication of the network device, or if the network device does not indicate the value of N_{TA}, the value of N_{TA} is 0; a value of N_{TA,offset} is determined based on an indication of the network device, or if the network device does not indicate the value of N_{TA,offset}, the value of N_{TA,offset} is a default value; a value of

$${N}_{TA , adj}^{common}$$

is determined based on a higher-layer parameter configured on a network side, or if the higher-layer parameter is not configured on the network side, the value of

$${N}_{TA , adj}^{common}$$

is 0, and if ephemeris information of the network device is configured,

$${N}_{TA , adj}^{UE}$$

is determined based on position information of the terminal device and the ephemeris information of the network device, or if the ephemeris information of the network device is not configured, a value of

$${N}_{TA , adj}^{UE}$$

is 0.

In an embodiment, the communication apparatus 1000 may perform the following functions:
sending first information, where the first information indicates a first value; the first value, N_{TA}, N_{TA,offset},

$${N}_{TA , adj}^{common} , {N}_{TA , adj}^{UE}$$

are used to determine a sending time point of a random access request; a value of N_{TA} is determined based on an indication of the network device, or if the network device does not indicate the value of N_{TA}, the value of N_{TA} is 0; a value of N_{TA,offset} is determined based on an indication of the network device, or if the network device does not indicate the value of N_{TA,offset}, the value of N_{TA,offset} is a default value; a value of

$${N}_{TA , adj}^{common}$$

is determined based on a higher-layer parameter configured on a network side, or if the higher-layer parameter is not configured on the network side, the value of

$${N}_{TA , adj}^{common}$$

is 0; and if ephemeris information of the network device is configured,

$${N}_{TA , adj}^{UE}$$

is determined based on position information of the terminal device and the ephemeris information of the network device, or if the ephemeris information of the network device is not configured, a value of

$${N}_{TA , adj}^{UE}$$

is 0; and
receiving the random access request from the terminal device.

The foregoing is merely an example. The processing unit 1001 and the communication unit 1002 may further perform other functions. For more detailed descriptions, refer to related descriptions in the foregoing method embodiments. Details are not described herein again.

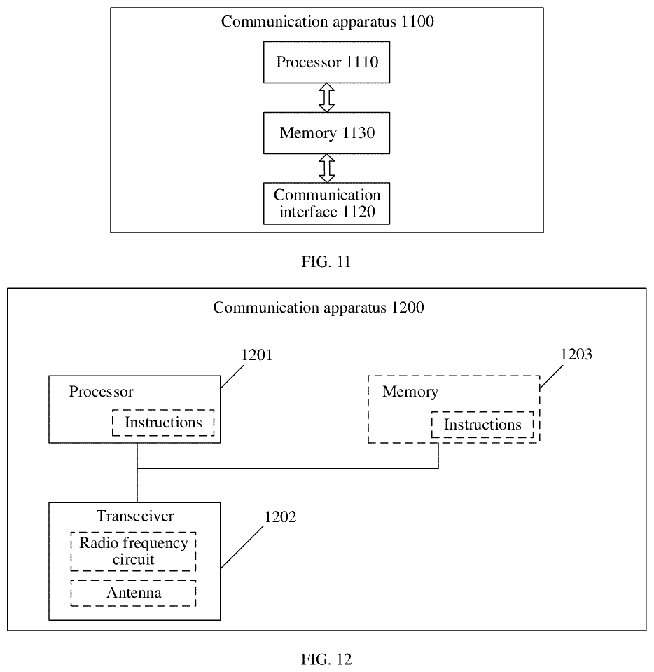

FIG. 11 shows a communication apparatus 1100 according to an embodiment. The apparatus shown in FIG. 11 may be an embodiment of a hardware circuit of the apparatus shown in FIG. 10. The communication apparatus is applicable to the foregoing flowcharts, and performs functions of the network device or the terminal device in the foregoing method embodiments. For ease of description, FIG. 11 shows only main components of the communication apparatus.

As shown in FIG. 11, the communication apparatus 1100 includes a processor 1110 and a communication interface 1120. The processor 1110 and the communication interface 1120 are coupled to each other. It may be understood that the communication interface 1120 may be a transceiver or an input/output interface. Optionally, the communication apparatus 1100 may further include a memory 1130, configured to: store instructions executed by the processor 1110, store input data needed by the processor 1110 to run the instructions, or store data generated after the processor 1110 runs the instructions.

When the communication apparatus 1100 is configured to implement the foregoing methods, the processor 1110 is configured to implement a function of the processing unit 1001, and the communication interface 1120 is configured to implement a function of the communication unit 1002.

When the communication apparatus is a chip used in the terminal device, the chip of the terminal device implements the functions of the terminal device in the foregoing method embodiments. The chip of the terminal device receives information from another module (for example, a radio frequency module or an antenna) in the terminal device. Alternatively, the chip of the terminal device sends information to another module (for example, a radio frequency module or an antenna) in the terminal device.

In another possible product form, the terminal device or the network device in embodiments may be implemented by using a general bus architecture. For ease of description, FIG. 12 is a diagram of a structure of a communication apparatus 1200 according to an embodiment. The communication apparatus 1200 includes a processor 1201 and a transceiver 1202. The communication apparatus 1200 may be a terminal device, or a chip or a chip system in the terminal device. Alternatively, the communication apparatus 1200 may be a network device, or a chip or a module in the network device. FIG. 12 shows only main components of the communication apparatus 1200. In addition to the processor 1201 and the transceiver 1202, the communication apparatus 1200 may further include a memory 1203 and an input/output apparatus (not shown in the figure).

Optionally, the processor 1201 can be configured to: process a communication protocol and communication data, control the entire communication apparatus, execute a software program, and process data of the software program. The memory 1203 can be configured to store the software program and data. The transceiver 1202 may include a radio frequency circuit and an antenna. The radio frequency circuit can be configured to: perform conversion between a baseband signal and a radio frequency signal, and process the radio frequency signal. The antenna can be configured to receive and send a radio frequency signal in a form of an electromagnetic wave. The input/output apparatus, for example, a touchscreen, a display, or a keyboard, can be configured to receive data input by a user and output data to the user.

Optionally, the processor 1201, the transceiver 1202, and the memory 1203 may be connected through a communication bus.

After the communication apparatus is powered on, the processor 1201 may read the software program in the memory 1203, interpret and execute instructions of the software program, and process the data of the software program. When data needs to be sent wirelessly, the processor 1201 performs baseband processing on the to-be-sent data, and then outputs a baseband signal to the radio frequency circuit. The radio frequency circuit performs radio frequency processing on the baseband signal, and then sends a radio frequency signal to the outside in a form of an electromagnetic wave through the antenna. When data is sent to the communication apparatus, the radio frequency circuit receives a radio frequency signal through the antenna, converts the radio frequency signal into a baseband signal, and outputs the baseband signal to the processor 1201. The processor 1201 converts the baseband signal into data, and processes the data.

In another embodiment, the radio frequency circuit and the antenna may be disposed independent of the processor for baseband processing. For example, in a distributed scenario, the radio frequency circuit and the antenna may be disposed remotely and independent of the communication apparatus.

In some embodiments, in hardware embodiment, a person skilled in the art may figure out that the communication apparatus 1000 may be in a form of the communication apparatus 1200 shown in FIG. 12.

In an example, a function/implementation process of the processing unit 1001 in FIG. 10 may be implemented by the processor 1201 in the communication apparatus 1200 shown in FIG. 12 by invoking computer-executable instructions stored in the memory 1203. A function/implementation process of the communication unit 1002 in FIG. 10 may be implemented by the transceiver 1202 in the communication apparatus 1200 shown in FIG. 12.

It may be understood that the processor in embodiments may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any conventional processor.

The memory in embodiments may be a random access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a CD-ROM, or any other form of storage medium well known in the art. For example, a storage medium is coupled to the processor, so that the processor can read information from the storage medium and can write information into the storage medium. It is clear that the storage medium may alternatively be a component of the processor. The processor and the storage medium may be disposed in an ASIC. In addition, the ASIC may be located in a network device or a terminal device. Alternatively, the processor and the storage medium may exist in a network device or a terminal device as discrete components.

A person skilled in the art should understand that embodiments may be provided as a method, a system, or a computer program product. Therefore, the embodiments may use a form of hardware only embodiments, software only embodiments, or embodiments with a combination of software and hardware. In addition, the embodiments may use a form of a computer program product that is implemented on one or more non-transitory computer-usable storage media (including, but not limited to, a disk memory, an optical memory, and the like) that include computer-usable program code.

The embodiments are described with reference to the flowcharts and/or block diagrams of the method, the device (system), and the computer program product. It should be understood that computer program instructions may be used to implement each procedure and/or each block in the flowcharts and/or the block diagrams and a combination of a procedure and/or a block in the flowcharts and/or the block diagrams. These computer program instructions may be provided for a general-purpose computer, a dedicated computer, an embedded processor, or a processor of another programmable data processing device to generate a machine, so that the instructions executed by a computer or the processor of the another programmable data processing device generate an apparatus configured to implement a specific function in one or more procedures in the flowcharts and/or in one or more blocks in the block diagrams.

These computer program instructions may alternatively be stored in a non-transitory computer-readable memory that can indicate a computer or another programmable data processing device to work in a specific manner, so that the instructions stored in the non-transitory computer-readable memory generate an artifact that includes an instruction apparatus. The instruction apparatus implements a specific function in one or more procedures in the flowcharts and/or in one or more blocks in the block diagrams.

It is clear that a person skilled in the art can make various modifications and variations to the embodiments without departing from their scope. In this way, the embodiments are intended to cover these modifications and variations.

1. A method, comprising:
determining a first offset value, wherein the first offset value is used to send a random access request in advance;
decreasing the first offset value, and sending the random access request to a network device by using a decreased first offset value, wherein a timing advance adjustment value indicated by a random access response corresponding to the random access request sent by using the decreased first offset value is greater than or equal to 0; and
receiving the random access response from the network device.

2. The method according to claim 1, wherein the decreased first offset value satisfies the following form:
$${T}_{TA 1} = ( {N}_{TA} + {N}_{TA , offset} + {N}_{TA , adj}^{common} + {N}_{TA , adj}^{UE} - {N}_{offset} ) T ,$$
wherein
T_{TA1} represents the decreased first offset value, and a value of N_{TA} is determined based on an indication of the network device, or when the network device does not indicate the value of N_{TA}, the value of N_{TA} is 0; a value of N_{TA,offset} is determined based on an indication of the network device, or when the network device does not indicate the value of N_{TA,offset}, the value of N_{TA,offset} is a default value; a value of
$${N}_{TA , adj}^{common}$$
is determined based on a higher-layer parameter configured on a network side, or when the higher-layer parameter is not configured on the network side, the value of
$${N}_{TA , adj}^{common}$$
is 0; T represents a time unit; when ephemeris information of the network device is configured,
$${N}_{TA , adj}^{UE}$$
is determined based on position information of a terminal device and the ephemeris information of the network device, or when the ephemeris information of the network device is not configured, a value of
$${N}_{TA , adj}^{UE}$$
is 0; and N_{offset} is error information, and N_{offset} is greater than 0.

3. The method according to claim 2, wherein a value of the error information N_{offset} is indicated by the network device.

4. The method according to claim 2, wherein the error information is determined based on:
an ephemeris calculation error, wherein the ephemeris calculation error is an error generated when position information of the network device is determined based on the ephemeris information.

5. The method according to claim 1, wherein the random access response indicates the timing advance adjustment value, and the method further comprises:
determining a timing advance based on the timing advance adjustment value and the decreased first offset value, wherein the timing advance is used to send an uplink message.

6. A communication apparatus comprising:
at least one processor and at least one memory storing instructions; wherein the instructions are executed by the at least one processor to cause the apparatus to perform operations of:
receiving a random access request from a terminal device, wherein the random access request is sent by using a decreased first offset value, and the first offset value is used to send the random access request in advance; and
sending a random access response to the terminal device based on the random access request, wherein a timing advance adjustment value indicated by the random access response is greater than or equal to 0.

7. A communication apparatus comprising:
at least one processor and at least one memory storing instructions; wherein the instructions are executed by the at least one processor to cause the apparatus to perform operations of:
determining a first offset value, wherein the first offset value is used to send a random access request in advance;
decreasing the first offset value, and sending the random access request to a network device by using a decreased first offset value, wherein a timing advance adjustment value indicated by a random access response corresponding to the random access request sent by using the decreased first offset value is greater than or equal to 0; and
receiving the random access response from the network device.

8. The communication apparatus according to claim 7, wherein the decreased first offset value satisfies the following form:
$${T}_{TA 1} = ( {N}_{TA} + {N}_{TA , offset} + {N}_{TA , adj}^{common} + {N}_{TA , adj}^{UE} - {N}_{offset} ) T ,$$
wherein
T_{TA1} represents the decreased first offset value, and a value of N_{TA} is determined based on an indication of the network device, or when if the network device does not indicate the value of N_{TA}, the value of N_{TA} is 0; a value of N_{TA,offset} is determined based on an indication of the network device, or when if the network device does not indicate the value of N_{TA,offset}, the value of N_{TA,offset} is a default value; a value of
$${N}_{TA , adj}^{common}$$
is determined based on a higher-layer parameter configured on a network side, or if the higher-layer parameter is not configured on the network side, the value
$${N}_{TA , adj}^{common}$$
is 0; T represents a time unit; when ephemeris information of the network device is configured,
$${N}_{TA , adj}^{UE}$$
is determined based on position information of a terminal device and the ephemeris information of the network device, or when the ephemeris information of the network device is not configured, a value of
$${N}_{TA , adj}^{UE}$$
is 0; and N_{offset} is error information, and N_{offset} is greater than 0.

9. The communication apparatus according to claim 8, wherein a value of the error information N_{offset} is indicated by the network device.

10. The communication apparatus according to claim 8, wherein the error information is determined based on:
an ephemeris calculation error, wherein the ephemeris calculation error is an error generated when position information of the network device is determined based on the ephemeris information.

11. The communication apparatus according to claim 7, wherein the random access response indicates the timing advance adjustment value, and the operations further comprise:
determining a timing advance based on the timing advance adjustment value and the decreased first offset value, wherein the timing advance is used to send an uplink message.

12. The method according to claim 2, wherein the error information is determined based on:
a timing error, wherein the timing error is an error generated when a delay between the terminal device and the network device is determined based on the position information of the terminal device and the ephemeris information of the network device.

13. The method according to claim 2, wherein the error information is determined based on:
a positioning error, wherein the positioning error is an error generated when the position information of the terminal device is determined.

14. The method according to claim 2, wherein the error information is determined based on:
an interpolation error, wherein the interpolation error is an error generated when the position information of the terminal device and/or the ephemeris information of the network device are/is calculated in an interpolation manner.

15. The communication apparatus according to claim 8, wherein the error information is determined based on:
a timing error, wherein the timing error is an error generated when a delay between the terminal device and the network device is determined based on the position information of the terminal device and the ephemeris information of the network device.

16. The communication apparatus according to claim 8, wherein the error information is determined based on:
a positioning error, where the positioning error is an error generated when the position information of the terminal device is determined.

17. The communication apparatus according to claim 8, wherein the error information is determined based on:
an interpolation error, wherein the interpolation error is an error generated when the position information of the terminal device and/or the ephemeris information of the network device are/is calculated in an interpolation manner.
